(19) United States
(12) Patent Application Publication
(10) Pub. No.: US 2013/0046704 A1
(43) Pub. Date: Feb. 21, 2013

(54) Recruitment Interaction Management System

(71) Applicants: Nital P. Patwa, San Jose, CA (US); Rajiv Gupta, Los Altos, CA (US); Sanjiv Gupta, Hyderabad (IN); Adil Adi, Frisco, CA (US)

(72) Inventors: Nital P. Patwa, San Jose, CA (US); Rajiv Gupta, Los Altos, CA (US); Sanjiv Gupta, Hyderabad (IN); Adil Adi, Frisco, CA (US)

(21) Appl. No.: 13/584,843

(22) Filed: Aug. 14, 2012

Related U.S. Application Data
(60) Provisional application No. 61/575,030, filed on Aug. 15, 2011.

(51) Int. Cl. G06Q 10/06

(52) U.S. Cl. 705/321

(57) ABSTRACT

A computer implemented method and system for managing recruitment interactions provides a recruitment interaction management platform (RIMP) that acquires profile information associated with multiple roles from multiple users and recruitment advisory information from one or more of the users and/or first external sources via a network, for creating one or more candidate profiles for candidates. The RIMP matches the candidate profiles with a recruiting requirement acquired from one or more of the users or second external sources via the network, based on matching criteria to generate a candidate list that matches the recruiting requirement; dynamically assigns a rating to each of the users based on their roles, the profile information, an outcome of a transaction performed between recruiters and the candidates, and predetermined rating criteria associated with the roles; and allocates incentives to each of the users based on the roles, the assigned rating, and predetermined incentive allocation criteria.

### CROSS REFERENCE TO RELATED APPLICATIONS

This application claims the benefit of provisional patent application Ser. No. 61/575,030 titled “Business process and mechanism for job recruitment through referrals that are not necessarily tied to a particular job opening”, filed on Aug. 15, 2011 in the United States Patent and Trademark Office.

The specification of the above referenced patent application is incorporated herein by reference in its entirety.

### BACKGROUND

The rapid increase of online recruitment agencies, particularly registered recruitment websites has ensured that employment opportunities are presented to a wider community of candidates and that interactions between candidates and employers are facilitated. Conventional job search web sites assist candidates who are actively seeking a job position and who post resumes or search for posted jobs, and also assist employers or recruiters who post available jobs or search for posted resumes. Other community websites allow both active candidates and passive candidates to post their profiles online, and allow recruiters to search their profiles and solicit the candidates for available job openings. However, such solicitation does not work effectively for passive candidates because they do not like to be approached by unknown recruiters who may not offer them anything better than what they already have. Moreover, engaging the services of an unknown recruiter may jeopardize a user's current job. Furthermore, a number of recruitment websites have forayed into community sourced recruitment, that is, a recruitment process facilitated by creating a community of candidates, employers, recommenders, etc., that allows a quicker and smoother interaction among all the concerned parties resulting eventually in the recruitment of one or more candidates for job openings provided by the employers. However, conventional community sourced recruitment websites often require employers to publish job openings or request for candidate profiles prior to initiating the recruitment process. Conventional recruitment websites typically invite “referrers” or “recommenders” to refer a prospective candidate for a particular job opening. These recruitment websites require the identity of the referrer and that of the candidate that they recommended to be released to the recruitment website. These conventional recruitment websites are not equipped to allow anonymous recommendations that could be moderated by a community of users working in a particular technical area. Furthermore, these conventional recruitment websites require the referral to be for an existing job opening.

Consider an example where a company has frozen recruitment for a particular period of time but would like to determine whether there are candidates who would be interested in job openings in the company after the company has resumed recruitment. Since conventional recruitment websites proceed with initiating interaction between a candidate and an employer for recruitment related processes only after receiving information on an existing job opening, the abilities and referrals associated with prospective candidates that could be valuable to an existing open position, or to a position that may open up in the future, or to positions that are very likely to open up in the future, are often missed out. For example, a recommender, Tom, may provide a referral of a candidate Bill whose skills may be relevant to a position that software companies may have immediately or may have in the future, or whose skills may be relevant to the next job that Bill decides to take. However, the referral provided by Tom for Bill may not be accessed due to non-availability of a current job opening.

Furthermore, conventional recruitment websites allow users to refer their friends for specific job openings and allocate rewards for the referral. These recruitment websites typically do not have a built-in system that can determine the authenticity of a referral and dissuade users from making improper referrals which reduce the value of a referral and wastes the time and resources of prospective employers. For example, conventional recruitment websites often do not have a system that can check recommenders deliberately attempting to provide improper or unsubstantiated recommendations of a candidate, or check recommenders attempting to manipulate the system by blindly piling on recommendations to the recommendations already made by other users. Employers typically prefer having multiple recommenders for finding the best candidate. Conventional recruitment websites do not have a structured system that can share allocated incentives or rewards to multiple recommenders for the same candidate. For example, recruitment websites do not reward both Jane and Jake for submitting a recommendation for Don.

Furthermore, a candidate who is already employed in a company may not be immediately looking for a job opening but may want to determine whether he/she can find a job that fits his/her expectations in terms of salary compensation, job profile, etc. There is a need for a computer implemented method and system that provides candidates with the ability to include in their profile “make me move” criteria to allow these candidates to search for a better job or employment when they are already employed.

Furthermore, conventional recruitment websites often require manual coordination from recruiters to initiate discussions between prospective candidates and employers. To set up a convenient mode of interaction, participating entities are generally required to provide identification information such as a phone number, contact details, etc. The divulgence of identification information is not desirable for passive candidates as this may jeopardize their existing job. Also, unsolicited inquiries from recruiters are considered spam by passive candidates and most choose not to respond, thereby preventing recruiters from interacting with the best candidates. There is a need to change the process and create a recruitment website where passive candidates can specify their interests, for example, “make me move” criteria, and where recruiters can send inquiries only when an employer's posted job meets the “make me move” criteria. There is also a need for a recruitment website that allows interaction between the recruiter and the candidate without the candidate having to reveal their identification information, thereby allowing a passive candidate to explore his/her dream job without jeopardizing their current job.

Furthermore, conventional recruitment websites often allow only limited adjustments to privacy settings. A recommender who would like to provide a referral may, for example, wish to remain anonymous, or an employer who would like to ascertain the prospects of recruiting qualified candidates without committing to offering a job opening, may wish to remain anonymous. Conventional recruitment websites often fail to provide complete flexibility in terms of adjustable privacy settings for employers, candidates, and recommenders.

Furthermore, recommenders may wish to track the progress of the candidates recommended by them without having to communicate regularly with the recruiters or the recommended candidates. Moreover, conventional websites do not allow a recommender to submit a recommendation once and have it be in effect for multiple employers until the candidate selects a job without having to do any further manual processing. Moreover, a particular candidate recommended by a recommender may work in multiple organizations over a period of time and the recruitment of the candidate by each of the organizations may have been influenced by the recommendation of the recommender. However, conventional recruitment websites generally allocate monetary rewards to a recommender for recommending a candidate for a particular job opening as a one-time benefit and do not allow the recommender to earn rewards over a long period of time when the candidate changes his/her job in different organizations over his/her career.

Furthermore, employers may request for profiles and resumes to be screened by an external competent authority, herein referred to as “screeners”. Most conventional recruitment websites often do not provide a facility for screening candidates' credentials by experienced, competent screeners whose credibility can be verified by a well established community of experts in a particular technical area. Therefore, most employers are often compelled to sift through a large number of resumes or profiles which is a time consuming process. There is a need for a computer implemented method and system that allow screeners to register in one or more domains of their expertise while monetizing knowledge, judgment, and personal time to screen and select a qualified list of candidates for employers, and that allow employers to select screeners and assign the task of screening candidates while saving time and money for finding more qualified candidates.

Furthermore, conventional recruitment websites and community websites typically permit candidates to maintain only one profile on the recruitment website. Since there is a possibility of constant generation and evolution of different types of jobs, there is a need for maintaining multiple profiles that match different type of jobs. Moreover, there is need for a user to maintain separate profiles for each role, for example, a candidate profile, a recommender profile, a screener profile, etc.

Hence, there is a long felt but unresolved need for a computer implemented method and system that improve the efficiency and quality of the recruitment process by supporting and managing recruitment interactions, for example, by allowing candidates to specify “make me move” criteria to eliminate unsolicited inquiries, by allowing posting of multiple profiles for multiple roles with complete control over privacy, that is, control of who can see their profile and when, by allowing users to perform roles of recommenders and of screeners in different domains of expertise, and by managing a fair reward system to reward recommenders and screeners. Furthermore, there is a need for a computer implemented method and system that manages recruitment interactions independent of a recruiting requirement.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above stated needs for supporting and managing recruitment interactions, for example, by allowing candidates who are applying or who may apply for a recruiting requirement to specify user expectation information, herein referred to as “make me move” criteria, to eliminate unsolicited inquiries, by allowing posting of multiple profiles for multiple roles to be performed on a recruitment interaction management platform with complete control over privacy, that is, control of who can see their profile and when, by allowing users to perform roles of recommenders and of screeners in different domains of expertise, and by managing a fair reward system to reward users such as recommenders and screeners. As used herein, the term “recruiting requirement” refers to an employment position, an internship, etc., for example, a job profile posted on a graphical user interface (GUI) provided by the recruitment interaction management platform that defines, for example, a requirement for a set of educational qualifications, professional qualifications and skills, a required number of years of experience, soft skills, type of requirement related to recruitments such as recruitments for a job, recruitments for a student internship, or any other type of recruitment, etc.

The computer implemented method and system disclosed herein also provide incentives for individual users to add, enhance, or correct the profiles of other users and provide recommendations to those other users. The computer implemented method and system disclosed herein enable users to provide recommendations even if they are not friends or acquaintances of the person to whom they are giving the recommendations. Furthermore, the computer implemented method and system disclosed herein enable users to provide recommendations to other users even in the absence of a particular job opening that may fit the user to whom they are giving a referral or a recommendation. The computer implemented method and system disclosed herein do not require employers to publish job openings or required candidate profiles, and do not require recommenders to be friends or acquaintances of the users to whom they give recommendations, and do not require the recommendations to be for an existing job opening. Therefore, the computer implemented method and system disclosed herein enable an expedited development of a large data store containing information of candidates with rich, community-sourced profiles and recommendations. This large, rich data store can be referenced by employers for an effective recruitment process.

The computer implemented method and system disclosed herein improve the recruitment process, for example, for a job, by leveraging the power of a community through monetary incentives that encourage the creation of a rich and community-curated data store of candidates and recommendations or referrals but that at the same time preserves the value of the recommendations by disincentivizing undeserving and inaccurate recommendations that dilute the value of community recommendations.

The computer implemented method and system disclosed herein enables candidates to store one or more profiles with complete control over privacy, that is, enables candidates to control who can see what and when, in accordance with the premise that the best candidates do not want their resumes to be in the public domain. The computer implemented method and system disclosed herein allow candidates to include in their profile “make me move” criteria to allow the candidates to receive inquiries only from recruiters who can match their “make me move” criteria. Furthermore, the computer implemented method and system disclosed herein enable recommenders to store a list of candidates recommended by them for a particular area of expertise with complete control over their privacy settings. Furthermore, the computer implemented method and system disclosed herein enable screeners, that is, users who are qualified to screen candidates, to register themselves as screeners in their area of expertise. The computer implemented method and system disclosed herein provide recruiters or employers with the option of selecting screeners and assigning the task of screening candidates.

Furthermore, the computer implemented method and system disclosed herein describe steps for optimally sharing monetary rewards or incentives collected from recruiters or employers, whether through successful recruitment fees or other search fees, with a multitude of recommendation and screen contributors. Recruitment advisory information received from multiple recommenders and screeners serve as rich data for prospective recruiters or employers to select the right candidate. The computer implemented method and system disclosed herein provide methods for incentivizing users to add, enhance, or correct profiles and to submit only well-deserved recommendations for candidates. The computer implemented method and system disclosed herein prevent users from manipulating the system by blindly piling recommendations for a candidate, made by other users.

The computer implemented method and system disclosed herein manage recruitment interactions among multiple users associated with multiple roles. As used herein, the term “recruitment interactions” refers to contribution of recruitment advisory information, private communication among multiple users, for example, recruiters, candidates such as active candidates and passive candidates, recommenders, screeners, etc., during a process leading to the recruitment of the candidates, subsequent feedback communication from the recruiters, and subsequent allocation of incentives to one or more users. The roles of the users comprise, for example, a recruiter role, a screener role, a recommender role, an active candidate role, a passive candidate role, etc. The computer implemented method and system disclosed herein provide a recruitment interaction management platform comprising at least one processor configured to manage the recruitment interactions among the users. The recruitment interaction management platform is accessible to multiple users via a network.

The recruitment interaction management platform acquires profile information from each of the users via the graphical user interface (GUI) provided by the recruitment interaction management platform. The acquired profile information is associated with the roles to be performed by each of the users on the recruitment interaction management platform. The profile information comprises, for example, login information, identification information, contact information, qualification information, domains of expertise, links to third party sources that store profile information of each of the users, etc. The recruitment interaction management platform configures user adjustable privacy settings for providing selective access of the acquired profile information of each of the users to other users and for maintaining anonymity during the recruitment interactions.

The recruitment interaction management platform acquires recruitment advisory information from the users via the GUI based on the roles of each of the users, and/or from one or more first external sources via the network. As used herein, the term “first external sources” refers to social network sources comprising, for example, professional networking sources such as Linkedin® of LinkedIn Corporation, social media sources such as Facebook® of Facebook, Inc., etc. The recruitment advisory information comprises, for example, information on a recruiting requirement acquired from recruiters and/or one or more second external sources, one or more menu-driven recommendations acquired from recommenders, one or more screening results acquired from screeners, user expectation information acquired from candidates, and feedback information acquired from the recruiters via the GUI and/or one or more second external sources via the network. As used herein, the term “user expectation information” refers to criteria that define requirements of a job set by a user, for example, a salary expectation, a position title expectation, a field of interest, an acceptable work location, a desired organization culture, etc., that would make the user move from a current employment or a job to another more preferred employment or job. The user expectation information is herein referred to as “make me move” criteria, which allows candidates to search for a better job or employment when they are already employed. The “make me move” criteria allow passive candidates to specify their interests and receive inquiries from recruiters only when the recruiters' posted jobs meets the “make me move” criteria. The “make me move” criteria therefore eliminate unsolicited inquiries from recruiters. The feedback information comprises, for example, feedback from recruiters on candidates, recommenders, screeners, etc. Also, as used herein, the term “second external sources” refers to online resources, for example, published documents of market research surveys, job portals, company blogs, etc., that are retrieved by the recruitment interaction management platform, for example, from the internet.

In an embodiment, the GUI of the recruitment interaction management platform comprises one or more context sensitive interface elements that display contextual information based on preliminary inputs received from each of the users. In an embodiment, the recruitment interaction management platform acquires requests for screening one or more candidates via the GUI. The recruitment interaction management platform automatically assigns the acquired requests for the screening to one or more screeners among the users, and displays aggregated results of the screening received from the screeners to one or more recruiters on the GUI.

The recruitment interaction management platform verifies the authenticity of the acquired recruitment advisory information and allocates incentives to the users, for example, the recommenders, the screeners, etc., based on the authenticity of the acquired recruitment advisory information. In an embodiment, the recruitment interaction management platform utilizes the acquired recruitment advisory information for creating development programs and performance programs within an organization and for performing internal recruitment interactions within the organization.

The recruitment interaction management platform creates one or more candidate profiles for candidates using the recruitment advisory information and/or the acquired profile information. The creation of the candidate profiles is template driven, user generated, and structured. In an embodiment, the GUI of the recruitment interaction management platform comprises a configurable taxonomization interface for dynamically acquiring taxonomies from the users for classifying the created candidate profiles of the candidates.

The recruitment interaction management platform matches the created candidate profiles with a recruiting requirement acquired from the users, that is, the recruiters via the GUI and/or from one or more second external sources via the network based on matching criteria to generate a candidate list that matches the recruiting requirement. The matching criteria comprise, for example, one or more of educational qualifications, number of years of professional experience, professional skills, location, for example, a work location and a geographical location of the candidate, the work environment of an organization, financial benefits provided by the organization, one or more menu-driven recommendations, the user expectation information or “make me move” criteria, one or more screening results extracted from the recruitment advisory information, etc. The recruitment interaction management platform generates the candidate list that matches the recruiting requirement by processing, for example, recommendations, screening results, and user expectation information extracted from the recruitment advisory information, and sorting the created candidate profiles based on predefined categories. In an embodiment, the recruitment interaction management platform sorts the generated candidate list in a predefined priority order.

In an embodiment, the recruitment interaction management platform manages the recruitment interactions among the users independent of a recruiting requirement. In an embodiment, the recruitment interaction management platform provides a private messaging interface for exchanging messages between one of the users and another user in one or more of multiple communication modes, for example, a text communication mode, an image communication mode, a video communication mode, a voice communication mode, a multimedia communication mode, an instant messaging communication mode, etc. The identification information of the users is not revealed during the exchange. Furthermore, the recruitment interaction management platform groups the exchanged messages of the other user for unified access by the users. In an embodiment, the recruitment interaction management platform initiates the exchange of the messages between one of the users and another user via the private messaging interface on successful matching of the user expectation information extracted from the acquired requirement advisory information with the recruiting requirement.

The recruitment interaction management platform dynamically assigns a rating to each of the users based on the roles associated with each of the users, the acquired profile information, an outcome of a transaction performed between one or more recruiters and the candidates from the generated candidate list, and predetermined rating criteria associated with the roles. The predetermined rating criteria associated with the roles comprise, for example, one or more of votes from the users, a number of candidates successfully recruited by the recruiters, feedback from the recruiters on a status of the transaction with each of the candidates, a score assigned to each of the candidates selected by the recruiters, timestamps of recommendations extracted from the recruitment advisory information, etc. In an embodiment, the recruitment interaction management platform assigns the rating to each of the users by assigning weights to the profiles of each of the users based on the roles and/or weighting criteria, and by computing the rating for each of the users based on the assigned weights.

The recruitment interaction management platform allocates incentives to each of the users based on the roles, the assigned rating, and predetermined incentive allocation criteria. The predetermined incentive allocation criteria comprise, for example, one or more of the roles to be performed by each of the users, timestamps of recommendations extracted from the recruitment advisory information, a measure of a contribution of each the users during the recruitment interactions associated with the candidates, progress of the candidates being hired across multiple organizations, etc. The recruitment interaction management platform collects the incentives from the recruiters and performs the allocation of the collected incentives to the users who provide the recruitment advisory information. In an embodiment, the recruitment interaction management platform tracks the outcome of the transaction between the recruiters and the candidates for a predetermined time period, and allocates the incentives to one or more recommenders and one or more screeners that recommend and screen the candidates respectively, for each successful outcome of the transaction between the recruiters and the candidates.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing recruitment interactions among multiple users associated with multiple roles.

FIGS. 2A-2C exemplarily illustrate a flowchart comprising the steps for managing recruitment interactions, indicating the different roles that may be performed by a user of the recruitment interaction management platform.

FIGS. 3A-3C exemplarily illustrate a flowchart comprising the steps performed by an employer or a recruiter registered with the recruitment interaction management platform during recruitment interactions with other users.

FIGS. 4A-4W exemplarily illustrate screenshots of a graphical user interface provided by the recruitment interaction management platform for managing recruitment interactions among multiple users associated with multiple roles.

FIG. 5 exemplarily illustrates a schematic diagram showing multiple users that can perform recruitment interactions via the recruitment interaction management platform.

FIG. 6 exemplarily illustrates a computer implemented system for managing recruitment interactions among multiple users associated with multiple roles.

FIG. 7 exemplarily illustrates the architecture of a computer system employed by the recruitment interaction management platform for managing recruitment interactions among multiple users associated with multiple roles.

### DETAILED DESCRIPTION OF THE INVENTION

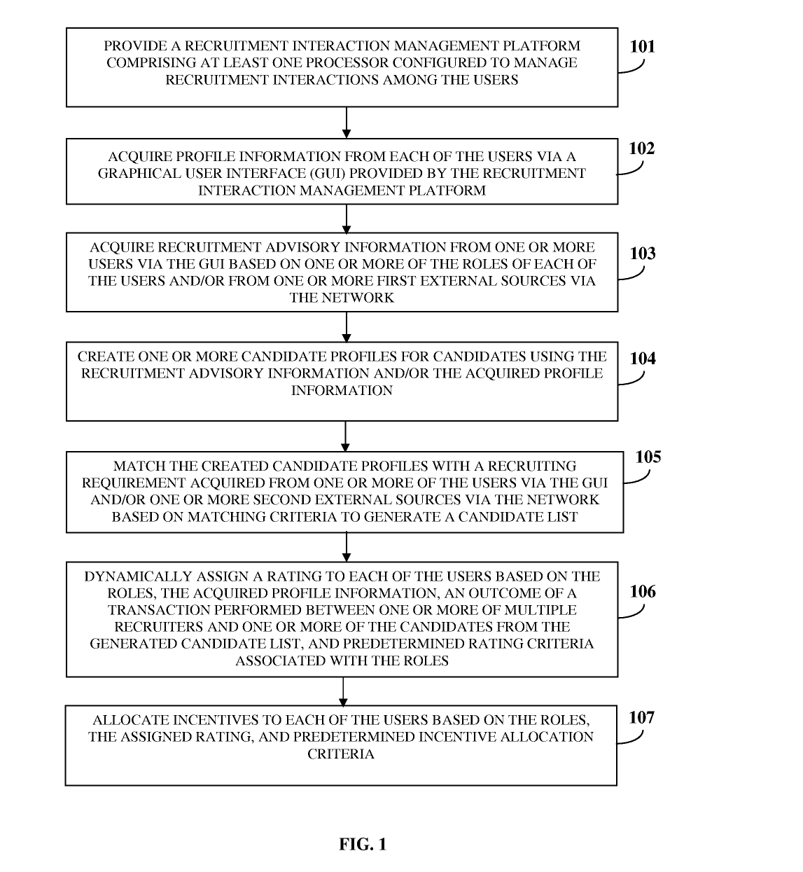

FIG. 1 illustrates a computer implemented method for managing recruitment interactions among multiple users associated with multiple roles. The computer implemented method disclosed herein provides 101 a recruitment interaction management platform comprising at least one processor configured to manage the recruitment interactions among the users. As used herein, the term “recruitment interactions” refers to contribution of recruitment advisory information, private communication among multiple users, for example, recruiters or employers, active candidates, passive candidates, recommenders, screeners, etc., during a process leading to the recruitment of the candidates, subsequent feedback communication from the recruiters, and subsequent allocation of incentives to one or more users. The term “recruiter” refers to an employer of an organization or a representative of an employer that is involved in the recruitment of one or more candidates for the employer. The recruiter is, for example, a human resource (HR) executive, an HR individual or entity working for an organization, an external consulting group that manages recruitment for a particular employer, a third party recruitment consultancy firm, an organization that recruits students or interns, etc. The recruiter or employer may be an organization, an individual, etc., that intends to recruit a candidate, or search for possible eligible candidates for jobs, research, internships, etc. Also, as used herein, the term “candidate” refers to a person seeking admission to an organization, a school, a company, an educational institution, etc. The term “active candidate” refers to a candidate who is actively seeking recruitment in an organization, a school, a company, an educational institution, etc., and the term “passive candidate” refers to a candidate who is not actively seeking recruitment but could be swayed into new employment if the new employment is or appears to be more attractive than the current employment. Also, as used herein, the term “recommender” refers to an individual or an entity that recommends or refers one or more candidates for one or more skills, or guarantees the competence of the candidates to a recruiter. Also, as used herein, the term “screener” refers to an individual or an entity that examines or screens one or more candidates for selection, rejection, consideration, etc., upon request from recruiters. The recruitment interaction management platform is accessible to multiple users via a network. The network is, for example, the internet, an intranet, a local area network, a wide area network, a communication network implementing Wi-Fi® of the Wireless Ethernet Compatibility Alliance, Inc., a cellular network, a mobile communication network, an ultra-wideband communication network (UWB), a general packet radio service (GPRS) network, an infrared communication network, a mobile telecommunication network such as a global system for mobile (GSM) communications network, a code division multiple access (CDMA) network, a third generation (3G) mobile communication network, etc. In an embodiment, the recruitment interaction management platform is implemented as a website hosted, for example, on an online server or a network of servers. The recruitment interaction management platform may be implemented internally within an organization for managing internal recruitment interactions, or as a consumer facing website for managing internal and external recruitment interactions.

In an embodiment, the recruitment interaction management platform registers the users, for example, the candidates, the recruiters, the screeners, the recommenders, etc., for creating user profiles. In an example, a new user may register with the recruitment interaction management platform by providing an electronic mail (email) identity (ID), such as a Facebook® ID or a Linkedin® ID and a corresponding password. The recruitment interaction management platform creates a new password for the user and transmits a link to the email ID of the user, which directs the user to return to the recruitment interaction management platform, enter the new password, and complete the registration. The recruitment interaction management platform acquires 102 profile information from each of the users via a graphical user interface (GUI) provided by the recruitment interaction management platform.

The GUI of the recruitment interaction management platform comprises, for example, a set of web pages that display menus, interfaces, tabs, links, etc., for entering requested information. In an example, the GUI displays a home web page with messages such as “recruiting with people power”, “getting a dream opportunity while already having a good opportunity”, etc., along with statistical information on the number of users recruited, the number of users who have registered with the recruitment interaction management platform for one or more roles, etc. The recruitment interaction management platform displays intuitive and interactive web pages with reports and interesting information that is of use to the users of the recruitment interaction management platform. The acquired profile information is associated with the roles to be performed by each of the users on the recruitment interaction management platform. The roles to be performed by each of the users comprise, for example, a recruiter role associated with an employer, an external recruiter, a human resource (HR) employee, etc., a screener role, a recommender role, an active candidate role, a passive candidate role, etc. Each user may perform one or more roles using the same login credentials.

The profile information comprises, for example, login information, identification information such as name, an electronic mail identifier (email ID) of the user, etc., contact information such as a telephone number, contact address of the user, etc., qualification information, domains of expertise, links to third party sources that store profile information of each of the users. The third party sources comprise, for example, social network sources such as Linkedin® of LinkedIn Corporation, professional information databases, etc. The recruitment interaction management platform acquires user expectation information from the candidates. In an embodiment, the user expectation information is included in the candidate profiles to allow the candidates to search for better employment when they are already employed. As used herein, the term “user expectation information” refers to criteria that define requirements of a job set by a user, for example, a salary expectation, a position title expectation, a field of interest, an acceptable work location, a desired organization culture, etc., that would make the user move from a current employment or a job, to another more preferred employment or job.

In an embodiment, the recruitment interaction management platform acquires user account information, for example, from human resource (HR) division employees, third party recruiters such as consultants, etc., working for an employer, etc. The HR employees, the third party recruiters, etc., enter employer account details on the recruitment interaction management platform via the GUI. A third party recruiter may add the employer account details of multiple employers, for whom he/she works. The recruitment interaction management platform provides role specific web pages from which the user can create and/or change profiles or view reports.

The recruitment interaction management platform configures user adjustable privacy settings for providing selective access of the acquired profile information of a user, for example, a prospective candidate to one or more other users, for example, employers or recruiters, and for maintaining anonymity during the recruitment interactions. The recruitment interaction management platform allows the candidate to adjust the privacy settings of the user profile on the recruitment interaction management platform, by providing selective access to a particular employer and blocking access to another employer. The recruitment interaction management platform provides a user controlled privacy layer that hides multiple interface elements, for example, the configurable fields of the profile information such as the identification information of the user. The recruitment interaction management platform displays the fields only when the user explicitly removes the privacy layer and therefore opens the user profile to one or more employers. Furthermore, the recruitment interaction management platform provides interface options on the GUI using which recommenders can elect to keep their recommendations anonymous or can choose to be selectively or completely public about their recommendations. Therefore, a recommender can select whether the candidate to whom the recommender is providing a recommendation, or a potential employer, has access to their full identity or partial identity, whether the candidate has access to their recommendation even if the candidate himself/herself is anonymous, etc. An example of partial identity that may be useful to the recruitment interaction management platform is the company, organization, or other community affiliations such as membership to technical groups, etc., of the recommender. In an embodiment, the recruitment interaction management platform and prospective employers are allowed access to the rating and other anonymous information of the recommenders of a candidate, for example, the number of recommendations provided by the recommender, etc., in order to decide how much weight needs to be provided to a recommender for a particular recommendation. In an example, an active candidate may provide selective access to his/her profile information for viewing by any employer on the GUI, but may restrict access to the user expectation information for viewing by employers.

Furthermore, the recruitment interaction management platform provides interface elements, for example, buttons, boxes, fields, etc., on the GUI for selection by a candidate to allow the candidate to modify or remove the privacy settings for a particular employer to allow the employer to fully evaluate the candidate. The interface elements enabling modification of the privacy settings can be presented in the form of a button on the GUI when the candidate is viewing messages from the employer. The recruitment interaction management platform notifies the candidate, for example, through pop-up messages, alerts, etc., when a particular employer has indicated interest in the candidate. The recruitment interaction management platform allows a candidate to remove the privacy layer for all employers, or remove the privacy layer selectively for certain employers.

The recruitment interaction management platform acquires 103 recruitment advisory information from one or more of the users via the GUI based on the roles of each of the users, and/or from one or more first external sources via the network. As used herein, the term “first external sources” refers to social network sources comprising, for example, professional networking sources such as Linkedin® of LinkedIn Corporation, social media sources such as Facebook® of Facebook, Inc., twitter® of Twitter, Inc., etc. The recruitment advisory information is an aggregated collection of recruitment related data for a particular industry. The recruitment advisory information comprises, for example, information on a recruiting requirement such as a job posting, a posting on a summer job or an internship, etc., acquired from the users in the recruiter role or from second external sources via the network, one or more menu-driven recommendations acquired from the users in the recommender role, one or more screening results acquired from the users in the screener role, user expectation information, herein referred to as, “make me move” criteria acquired from the users in the candidate role, feedback information on candidates, recommenders, and screeners acquired from users in the recruiter role via the GUI and/or from one or more second external sources via the network. As used herein, the term “recruiting requirement” refers to an employment position, an internship, etc., for example, a job profile posted on the GUI that defines, for example, a requirement for a set of educational qualifications, professional qualifications and skills, number of years of experience, soft skills, type of requirement related to recruitments such as recruitments for a job, recruitments for a student internship, or any other type of recruitment, etc. The user expectation information or “make me move” criteria allow candidates to search for a better employment or job when they are already employed. The “make me move” criteria allow passive candidates to specify their interests and receive inquiries from recruiters only when the recruiters' posted jobs meets the “make me move” criteria. The “make me move” criteria therefore eliminate unsolicited inquiries from recruiters. Also, as used herein, the term “second external sources” refers to online resources, for example, published documents of market research surveys, job portals, company blogs, etc., that are retrieved by the recruitment interaction management platform, for example, from the internet.

The recruitment advisory information that is independent of the recruiting requirement comprises, for example, the candidate's profile information, recommendations, etc. The recruitment advisory information that is dependent on the recruiting requirement comprises, for example, the recruiter's feedback, the screening results, etc. The recruitment advisory information allows creation of a self regulating system that separates good knowledge from noise or fake knowledge and that allows contributors, for example, the recruiters, the recommenders, the screeners, etc., to monetize the knowledge. In an embodiment, the recruitment interaction management platform utilizes the acquired recruitment advisory information for creating development programs and performance programs within an organization and for performing internal recruitment interactions within the organization. For example, an employer in an organization may provide access of the recruitment interaction management platform to current employees of the organization to allow the employees to confidentially express their career goals in the form of a modified version of the “make me move” criteria on the GUI of the recruitment interaction management platform and give feedback for other co-employees in the form of recommendations on the GUI. The employer can use this recruitment advisory information for human resources development, performance management programs, and for internal recruiting. In this embodiment, the recruitment interaction management platform is implemented internally within an organization for managing recruitment interactions within the organization. For example, the recruitment interaction management platform is implemented internally within a human resource (HR) department of an organization for managing internal recruiting.

The recruitment interaction management platform acquires recommendations from a recommender, observations and screening results recorded by screeners, for example, that candidates who have graduated from a particular university are more likely to perform well in a particular technical area, etc. The recruitment interaction management platform collects each recommendation from a recommender independent of the presence of other recommendations for a particular candidate to ensure unbiased recommendations and to prevent a recommender from piling on recommendations based on the number of recommendations already received by a user. The recruitment interaction management platform does not reveal the recommendations provided by a recommender to other users. For example, if recommender Mark wrote five recommendations for candidate Allen, another user Nancy cannot search for Mark on the recruitment interaction management platform and find out whom Mark is recommending. A recruiter can find out that Mark recommended Allen only after Mark and Allen remove the privacy layer for a job posted by this recruiter, but the recruitment interaction management platform does not allow the recruiter to share this information with other recommenders on the recruitment interaction management platform. Furthermore, for any individual recommender, the recruitment interaction management platform precludes the recommender from piling random recommendations because poor recommendations result in negative feedback from recruiters and negative feedback adversely affects the ratings assigned to the recommenders by the recruitment interaction management platform. Each recommendation serves as a testimonial of one or more of the technical skills, educational qualifications, personal attributes of the candidate, work related achievements, etc.

The recruitment interaction management platform timestamps each individual recommendation so that recommenders who provide an early recommendation to a candidate may benefit more. The recruitment interaction management platform allows a recommender to create a recommendation with menu-driven choices displayed on the GUI to ensure that content of a recommendation is legally clean and suitable for a candidate. The recommendations created using menu-driven choices selectable on the GUI of the recruitment interaction management platform are herein referred to as “menu-driven” recommendations. This minimizes the possibility of abuse of the option to provide a recommendation to a candidate. A recommender can create multiple recommendations. For example, if Mark Zuckerburg were to recommend Dustin Moskovitz, the recommendation created on the recruitment interaction management platform may appear as:

“Dustin Moskovitz, Silicon Valley, Developer in Java Software. He created the “Wall” concept in social networks. Dustin is passionate and hardworking.”

The recruitment interaction management platform allows a prospective recruiter such as a hiring company to look for candidates equipped with strong recommendations even before the hiring company publishes a recruiting requirement, for example, a job requisition. This allows a hiring manager to understand the size and pool of potentially available candidates, for example, when making decisions on project schedules that involve newly recruited candidates.

Furthermore, while providing the profile information and the recruitment advisory information, in order to minimize the amount of keyboard input required from a user when the user, for example, uses an interface of a tablet computing device such as the iPad® of Apple, Inc., the recruitment interaction management platform sets high level categories on the GUI from which the user may select a category. Since the categories are basic categories that may not include all possible job categories, the recruitment interaction management platform allows the user to select a miscellaneous “other” category and enter a new category, and the recruitment interaction management platform allows selection and prioritization of the categories based on open requirements in the recruitment interaction management platform. For example, a user may select a particular category such as a Java developer, a user interface (UI) designer, a quality assurance (QA) and test engineer, enterprise software sales, software as a service (SaaS) operations, etc. Depending on the category, the recruitment interaction management platform configures sliders for detailed characteristics such as the number of years of experience, ability to work independently, etc. This, for example, minimizes data entry allowing a user to operate on the recruitment interaction management platform using a computing device, for example, the iPhone® of Apple, Inc., or an Android® computing device of Google, Inc., while waiting for a friend, etc.

Furthermore, the recruitment interaction management platform displays a relationship cloud visually partitioned and color coded by the category and the candidate for whom a recommendation was provided, the performance of the candidates in terms of being discovered by recruiters or employers, the recruiters or employers recruiting the candidate, the recommenders recommending the candidate, etc., on the GUI. The recruitment interaction management platform modifies the relationship cloud based on how the recommendation provided by a recommender on a scale of 1 to 10 compares with the recommendation provided by other recommenders who have also recommended the same candidate.

The recruitment interaction management platform creates 104 one or more candidate profiles for the candidates using the recruitment advisory information and/or the acquired profile information. The recruitment interaction management platform aggregates the profile information and the recruitment advisory information provided by the users playing different roles and generates candidate profiles which are then matched. The creation of the candidate profiles is template driven, user generated, and structured. For example, the recruitment interaction management platform creates a web page on a particular candidate detailing the academic qualifications, professional skills, etc., of the candidate, the recommendations received by the candidate, the organizations that have employed the candidate, etc., without revealing the identity of the candidate as defined in the user adjustable privacy settings. Since there is a possibility of constant generation and evolution of different types of jobs, the recruitment interaction management platform maintains multiple profiles for candidates that match different types of recruiting requirements.

In an embodiment, the GUI of the recruitment interaction management platform comprises one or more context sensitive interface elements that display contextual information based on preliminary inputs received from each of the users. The interface elements are, for example, fields, boxes, etc. The recruitment interaction management platform collects primary data stored for each candidate from a candidate profile. The candidate profile comprises, for example, template driven, user generated, structured content. In an example, the recruitment interaction management platform provides a template in the form of an online form configured with buttons and menus. The template comprises, for example, a static component and a context sensitive component. Each field in the static component of the template is associated with an appropriate context sensitive component. For example, when a user enters “application-specific integrated circuit (ASIC) designing” as an area of expertise in a static component of the user profile, the recruitment interaction management platform automatically configures technical areas specific to ASIC for the user to complete in the context sensitive component on the GUI.

In another embodiment, the recruitment interaction management platform provides a configurable taxonomization interface on the GUI for dynamically acquiring taxonomies from one or more of the users for classifying the created candidate profiles of the candidates. The recruitment interaction management platform classifies the candidate profiles for expediting the steps of retrieving candidate profiles and matching the retrieved candidate profiles with the recruiting requirement acquired from a particular recruiter or an employer. The configurable taxonomization interface is, for example, in the form of a configurable template that enables each of the users to add or modify fields used for classifying the candidate profiles. For example, the recruitment interaction management platform allows users from among a community of professionals in a particular technical area of expertise to suggest new fields for a profile or otherwise enhance the templates provided by the recruitment interaction management platform. In an example, the community may recommend that the recruitment interaction management platform add a “willingness to relocate” field that may not have been included in the original template provided by the recruitment interaction management platform. The recruitment interaction management platform provides a starting set of common job profiles, for example, “Java programmers”, and then allows the community to create their own job profiles. For example, the recruitment interaction management platform allows a registered user, Tim, to provide a recommendation for a particularly skilled parrot trainer, John, whom he met while on a trip to Disneyland, without waiting for the recruitment interaction management platform to create an exclusive category for parrot trainers. Therefore, the recruitment interaction management platform enables the creation of new job taxonomies. Such community contributed taxonomies can follow a community curated and censored model similar to Wikipedia® of Wikimedia Foundation, Inc., or Craigslist® of Craigslist, Inc., in order to avoid inadvertent or advertent abuse of the option of providing recommendations for unintended purposes.

In an embodiment, the recruitment interaction management platform acquires requests for screening one or more candidates via the GUI. The recruitment interaction management platform automatically assigns the acquired requests for screening to one or more screeners among the users. For example, the recruitment interaction management platform informs the users in the screener role of the acquired requests and allows the users in the screener role to perform the requested screening on their own and post the screening results on the GUI. The recruitment interaction management platform also allows the recruiters to choose specific screeners for their requests. The recruitment interaction management platform displays the aggregated results of the screening received from the screeners to the recruiters on the GUI. A screener, in the context of the computer implemented method disclosed herein, is a virtual recruiter. The requests for screening assigned to each of the screeners comprise, for example, requests for reviewing candidate profiles or resumes for the quality of the candidate profiles or resumes, matching the candidate profiles or resumes against posted jobs, and posting the results of the screening. The requests for screening assigned to each of the screeners further comprise, for example, initiating a preliminary telephonic screening round through a telephonic interview to screen candidates based on their skill set, matching candidates against posted jobs, and posting the results of the screening. The recruitment interaction management platform disclosed herein enables screeners to register in one or more domains of their expertise while monetizing knowledge, judgment, and personal time to screen and select a qualified list of candidates for employers.

The recruitment interaction management platform matches 105 the created candidate profiles with a recruiting requirement acquired from one or more of the users via the GUI and/or one or more second external sources via the network based on matching criteria to generate a candidate list that matches the recruiting requirement. In an embodiment, the recruitment interaction management platform sorts the generated candidate list in a predefined priority order. The matching and sorting criteria comprise, for example, one or more educational qualifications, number of years of professional experience, professional skills, location such as a work location and a geographical location of the candidate, the work environment of an organization, financial benefits provided by the organization, one or more menu-driven recommendations such as a positive recommendation or a negative recommendation, user expectation information, and one or more screening results extracted from the recruitment advisory information. The recruitment interaction management platform generates the candidate list that matches the recruiting requirement by processing the recommendations, the screening results, and the user expectation information extracted from the recruitment advisory information, and by sorting the created candidate profiles based on predefined categories. The recruitment interaction management platform sorts the candidate profiles, for example, based on predefined categories such as education, rating of the candidate's school, past employers, rating of the employers for a skill, etc.

In order to match the created candidate profiles with the recruiting requirement, the recruitment interaction management platform provides a template for each industry, which comprises a set of parameters for matching. Consider an example of a template for the information technology industry. The recruitment interaction management platform, for example, applies profile match algorithms based on parameters derived from statistical market surveys such as which employers are considered good employers for a particular type of skill, which schools are considered as good schools for a particular technical area, etc. The recruitment interaction management platform may crowd-source these set of parameters, for example, by deriving the parameters from public surveys and market research. The parameters are, for example, broadly divided into qualification match parameters, criteria match parameters, and employer defined job profile information. The qualification match parameters define the academic and professional qualifications of the candidate. The criteria match parameters define the work expectations of the candidate.

The qualification match parameters comprise, for example, a general expertise area such as “software”, a job function such as “developer”, number of years of experience in a particular skill such as Java® programming—5 years, Ruby programming—2 years, etc., educational qualifications comprising, for example, degree, major subjects, grade point average (GPA), a school name or a school ranking, names of employers, an employer rating, market size of the employer, etc. The criteria match parameters comprise, for example, financial benefits such as a salary range, an availability of a bonus and percentage of availability of the bonus, compensation and a percentage of compensation, insurance benefits, career objective of a candidate, geography, that is, the expected work location of a company, work culture, for example, fast paced work environment demanding longer hours of work by an employee, a balanced work culture, etc., particular names of employers, etc. The recruitment interaction management platform searches for a match considering one or more of the qualification match parameters and the criteria match parameters.

The employer defined job profile information comprises, for example, structured job descriptions along with search tags to zoom into specific skills and job parameters that fit with the “make me move” criteria. Consider an example where the employer is looking for an engineer with core competence in the field of long term evolution (LTE) who is good at C programming, and has previously worked in large sized teams. The search tags, for this example, read as “LTE”, “C programming”, “large sized teams”. The job parameters comprise, for example, compensation that the employer is willing to pay, the work location, etc. A back end business logic of the recruitment interaction management platform processes the job profile information and the candidate profiles defined by the qualification match parameters and the criteria match parameters and dynamically produces best-match results for each job description on an employer's web page. In an example, the recruitment interaction management platform generates a similarity score based on the degree of match between a parameter defined in the recruiting requirement and the qualifications listed in the candidate profile and computes an overall score for the candidate based on the highest similarity score. The recruitment interaction management platform sorts the results with the highest scoring candidates appearing, for example, first in the candidate list. The employer can view details of the matched results and read the recommendations for the candidates associated with the matched candidate profiles on the GUI. However, the employer may determine the identity of the candidate if the candidate has removed the privacy layer.

In an embodiment, the recruitment interaction management platform manages the recruitment interactions among the users independent of a recruiting requirement. In an embodiment, the recruitment interaction management platform provides a private messaging interface for exchanging messages between a user and another user in one or more of multiple communication modes, for example, a text communication mode, an image communication mode, a video communication mode, a voice communication mode, a multimedia communication mode, an instant messaging communication mode, etc. The recruitment interaction management does not reveal the identification information of the users during the private exchange of messages. Furthermore, the recruitment interaction management platform groups the exchanged messages of the other user for unified access by the users. In an embodiment, the recruitment interaction management platform initiates the exchange of the messages between a user and another user via the private messaging interface on successful matching of the user expectation information extracted from the acquired requirement advisory information with the recruiting requirement.

In an example, the recruitment interaction management platform provides a private messaging interface for users in the form of an “inbox” that allows one to one messaging between a candidate and a prospective employer. The messages are, for example, in the form of textual short message service (SMS) messages, electronic mails (emails), portable document format (PDF) documents, images, live videos, etc. The messages do not reveal the actual identity of a candidate. However, the identity of the employer is by default open or revealed. The private messaging interface supports a threaded user interface for the “inbox”. Consider an example where a short message service (SMS) interface of the iPhone® device of Apple, Inc., can be used by a user to check all messages exchanged with a particular other user. In this example, the recruitment interaction management platform tracks and stores thread conversations associated with a user-employer pair. Therefore, a user can view all the communication exchanged with a particular employer in a thread. Furthermore, if a candidate has communicated with a screener, a recruiter, and a human resource (HR) employee, all working for a particular employer, the recruitment interaction management platform groups all the messages associated with the candidate in a unified thread.

Furthermore, the recruitment interaction management platform supports other modes of communication such as voice communication, video communication, etc., that enable private messaging between a user and another user. The voice communication interface configured by the recruitment interaction management platform allows two or more users to initiate a voice conversation without having to exchange their respective telephone numbers. Therefore, the voice communication interface allows users to take part in a group voice chat session for recruitment related communication exchanges. The video communication interface allows one or more users, for example, a candidate and a human resource (HR) executive working for a particular organization to take part in a video chat session.

The recruitment interaction management platform dynamically 106 assigns a rating to each of the users based on the roles associated with each of the users, the acquired profile information, an outcome of a transaction performed between one or more recruiters and the candidates from the generated candidate list, and predetermined rating criteria associated with the roles. The predetermined rating criteria associated with the roles comprise, for example, votes from the users, a number of candidates successfully recruited by the recruiters, feedback from the recruiters on a status of the transaction with each of the candidates, a score assigned to each of the candidates selected by the recruiters, timestamps of recommendations extracted from the recruitment advisory information, etc. In an example, an employer can provide feedback to a candidate on a scale of 1 to 5 or provide 1 to 5 stars on the GUI after an interview process. The recruitment interaction management platform acquires this feedback to determine the rating of the recommender who recommended the candidate. However, the feedback does not affect the particular candidate. The timestamp of a recommendation determines the time at which a recommender has provided a recommendation to a candidate. The recruitment interaction management platform assigns a higher rating to a recommender who provides a first recommendation to a candidate since the recommender does not have a precedent and takes the risk of recommending a candidate for the first time.

In an embodiment, the recruitment interaction management platform assigns weights to the profiles of each of the users based on their roles and weighting criteria, and computes the rating for each of the users based on the assigned weights. Since a user may be a candidate as well as a recommender, in an example, the recruitment interaction management platform divides the user profiles into micro-profiles based on the particular role that the user performs, such as a candidate, a screener, a recommender, etc. The recruitment interaction management platform assigns weights to each of the micro-profiles separately. Consider an example where the recruitment interaction management platform assigns weights for a user profile of each of the users. The recruitment interaction management platform first assigns an absolute weight to each micro-profile based on weights assigned for the user's graduate school and employers. The recruitment interaction management platform assigns weights to schools and employers on the basis of statistical analyses and market surveys conducted by established experts in a technical area. The recruitment interaction management platform assigns a popularity weight to each micro-profile of a user based on the number of recommenders that the micro-profile attracts and the individual weight assigned to the recommender, the number of employers that the user's micro-profile attracts and the individual weight assigned to each employer, etc. The recruitment interaction management platform then computes, for example, a weighted average of the absolute weight and the popularity weight of the user to derive a uniform weighted score for each of the users. The weights assigned to the micro-profiles are separate from other micro-profiles and are independent of past feedback received from other users.

Furthermore, the recruitment interaction management platform assigns a weight to each of the recommenders. The recruitment interaction management platform determines the weight for the recommender using a combination of parameters, for example, strength of the recommender's micro-profile as measured through absolute weights obtained from the weights associated with the recommender's school and employers, strength of the recommender's micro-profile as measured by a number of other recommenders that refer to the recommender's micro-profile, history of success of the candidates recommended by the recommender, etc. The success of a particular recommendation is measured by an outcome of a transaction which may, for example, be that the recommended micro-profile is liked by a recruiter but the actual recruitment did not take place due to unavailability of the candidate, that the candidate for whose micro-profile the recommender provided a recommendation is recruited by a company, etc.

Furthermore, the recruiter management platform assigns a customer weight to a micro-profile of a recruiter, for example, an HR employee, based on the outcome of the transaction, which is, for example, that the recommended micro-profile is liked by a customer, for example, a company, but actual recruitment could not take place due to unavailability of the candidate, that the candidate associated with the recommended micro-profile is recruited by the customer, etc.

Furthermore, the recruitment interaction management platform allows a user to influence his/her matching by explicitly notifying the recruitment interaction management platform that he/she is available or not available for recruitment by a particular employer. A candidate who is not immediately available for recruitment is herein referred to as an “inactive candidate”. In other embodiments, the recruitment interaction management platform supports alternative pricing models, such as one where businesses pay a subscription fee or a per-request fee to search for candidates on the recruitment interaction management platform.

Furthermore, the recruitment interaction management platform records all user actions that lead to monetization, with a timestamp. The recruitment interaction management platform collects a recruiting fee from the recruiter after successful recruitment and then distributes the fee as payment to one or more users and to the recruitment interaction management platform itself as profit. Thus, a successful recruitment is monetized by the users and the recruitment interaction management platform. The recruitment interaction management platform records the user actions in order to form a verifiable record for eligibility of payment from the recruiter. The user actions comprise, for example, the entry of a recommendation by a recommender, communication between an employer and a candidate, removal or modification of privacy settings by a candidate for an employer to allow evaluation of the candidate by the employer, etc.

The recruitment interaction management platform allocates 107 incentives to each of the users based on the roles, the assigned rating, and predetermined incentive allocation criteria. The incentives are, for example, in the form of monetary rewards, payments, points redeemable for cash, points redeemable for items of value, cash of value, coupons that could be encashed for buying one or more items, etc. The predetermined incentive allocation criteria comprise, for example, the roles performed by each of the users, timestamps of recommendations extracted from the recruitment advisory information, a measure of a contribution of each of the users during the recruitment interactions associated with the candidates, progress of the candidates being hired across multiple organizations, etc. In an example, the recruitment interaction management platform allows the recommenders to earn incentives over a long period of time as their recommended candidate gets hired by multiple organizations over his/her career. That is, a recommender can submit a recommendation once and have the recommendation be in effect for multiple employers as long as he/she chooses without having to perform any further manual processing. In an embodiment, the recruitment interaction management platform verifies the authenticity of the acquired recruitment advisory information and allocates the incentives to each of the users based on the authenticity of the acquired recruitment advisory information. In an example, the recruitment interaction management platform allows users to vote for the authenticity of the acquired recruitment advisory information. In another example, the recruitment interaction management platform allows recruiters to provide feedback which in turn affects the ratings of the recommenders and the screeners, which may be used to determine the authenticity of the acquired recruitment advisory information.

The allocation of the incentives by the recruitment interaction management platform is based on the fact that the higher a user's rating as a recommender or a contributor of a particular testimonial, or as a screener, the higher the user's share of the incentives, for example, monetary rewards would be. This rating system adopted by the recruitment interaction management platform incentivizes users to be discriminate in their recommendations and contributions so that they uphold and improve their own personal rating as a recommender or a contributor or a screener. The rating system takes into account a number of parameters, for example, community-based voting, the number of successful candidates that have been placed based on the recommendations provided by a recommender, an evaluation score that prospective employers have provided to the candidate profile or recommendations entered by other recommenders, etc. The concept of community voting is based on the fact that more often other recommenders, employers, etc., correct a candidate profile of a candidate or provide contradicting opinions on the candidates recommended by a particular recommender, the recruitment interaction management platform correspondingly lowers the rating of the recommender. Furthermore, a recommender's share of the incentives, for example, monetary rewards for a successful placement or recruitment of a candidate recommended by the recommender is also dependent on the relative order of the recommendations provided by the recommender, with earlier recommenders receiving a higher share modulated by their corresponding rating in order to incentivize users not to wait to add a profile or a recommendation at the recruitment interaction management platform.

In an embodiment, if the recommended candidate is recruited, the employer provides a fixed fee to the recruitment interaction management platform and a fixed reward to the recommenders and screeners. The recruitment interaction management platform distributes the reward among all the recommenders and screeners. The recruitment interaction management platform applies an incentive or payment calculation algorithm that calculates payment to each recommender and screener based on predetermined weight-based incentive allocation criteria comprising, for example, a time stamp of a recommendation or a screening result, a recommender's rating or a screener's rating, and a recommender's contribution or a screener's contribution in introducing the candidate. The payment calculated for each recommender and screener is proportional to the weight assigned to each recommender and screener. For example if there are three recommenders and the weights assigned to them are 0.5, 0.3, and 0.2, respectively then the payment is calculated as 0.5*total allocated payment, 0.3*total allocated payment, and 0.2*total allocated payment respectively.

In an embodiment, the recruitment interaction management platform allocates a positive incentive to a recommender on determining a successful outcome of a transaction performed between a recruiter and a candidate. On determining a negative outcome of the transaction between the recruiter and the candidate, the recruitment interaction management platform records the negative outcome against the recommender. The recruitment interaction management platform continues to track the outcomes of the transactions between the candidates recommended by the recommender and the recruiters and changes the assigned weights accordingly. Positive outcomes increase the weight, while negative outcomes decrease the weight.

The recruitment interaction management platform collects the incentives from the recruiters or the employers and performs the allocation of the collected incentives to the users, for example, the recommenders, the screeners, etc., who provide the recruitment advisory information. In an embodiment, the recruitment interaction management platform charges the employer a fixed fee for the recruitment interaction management platform and a fixed total reward for the users such as the recommenders, the screeners, etc., for example, in terms of a monetary payment. An employer views the amount to be paid to the recommenders on the GUI and accepts the amount as a part of posting a job. If an employer agrees to use screeners and have a portion of the fee allocated to screeners, the recruitment interaction management platform automatically informs screeners from a prestored list of available screeners and aggregates the screening results for the employer. The employer can transmit payment for the fees to a transaction account of the recruitment interaction management platform, for example, an account in PayPal® of Paypal, Inc. The recruitment interaction management platform receives the payment from the employer and credits a predetermined share of the payment to each of the users, for example, the recommenders and the screeners associated with the recruitment process, where the recruitment interaction management platform determines the individual share of the payment to each of the recommenders and the screeners based on the predetermined incentive allocation criteria. The recruitment interaction management platform acquires the account details of each of the users to be rewarded. The recruitment interaction management platform automatically transfers the payment to their accounts, for example, from the PayPal® account of the recruitment interaction management platform and transmits a notification to the users, for example, via an electronic mail (email), a pop-up alert, a short message service (SMS) message, etc.

The multiple sources of revenue that can be shared with users who provide recommendations, screening results, and other recruitment advisory information, and update profiles, allow the recruitment interaction management platform to potentially provide more incentives or monetary rewards to more users, thereby giving users a quicker positive reinforcement for contributing recommendations, screening results, recruitment advisory information, and recruitment related information to the recruitment interaction management platform without having to wait for a successful placement or recruitment based on the recommendations, screening results, etc. The computer implemented method disclosed herein thereby implements a process of giving users incentives or monetary rewards for contributing recommendations, screening results, and other recruitment advisory information to the recruitment interaction management platform even before the recommendations, screening results, etc., results in a successful placement for any type of referral-based recruitment service.

In an embodiment, the recruitment interaction management platform tracks the outcome of the transaction between the recruiters and the candidates for a predetermined time period and allocates the incentives to one or more recommenders and one or more screeners that recommend and screen the candidates respectively, for each successful outcome of the transaction between the recruiters and the candidates. This is based on the premise that a recommendation for the abilities of a candidate could be valuable to an existing open position, to a position that may open up in the future, or very likely to many positions that may open up in the future. Consider an example where recommender Tom's recommendation of candidate Bill's skills may be relevant to a position that a company DEF, PQR, and/or XYZ, currently have or may have in the future, and in fact may be relevant to the next job that Bill takes and perhaps even the jobs following that. Therefore, once Tom recommends Bill, the recruitment interaction management platform may allocate a share of the successful placement fee to Tom more than once. The recruitment interaction management platform tracks the transactions, for example, each of the interviews that Bill takes up over a period of a year. For each successful transaction, the recruitment interaction management platform allocates a predetermined share of the incentives to Tom. Therefore, Tom does not have to give a new recommendation for every possible job opening for which Bill may be a good candidate. The recruitment interaction management platform tracks a completed transaction, for example, a candidate being hired by an employer, and the payment that is due from that particular employer. For example, the recruitment interaction management platform tracks the users, for example, recommenders, screeners, etc., who contributed to the transaction and calculates the payments to be made to each of these users.

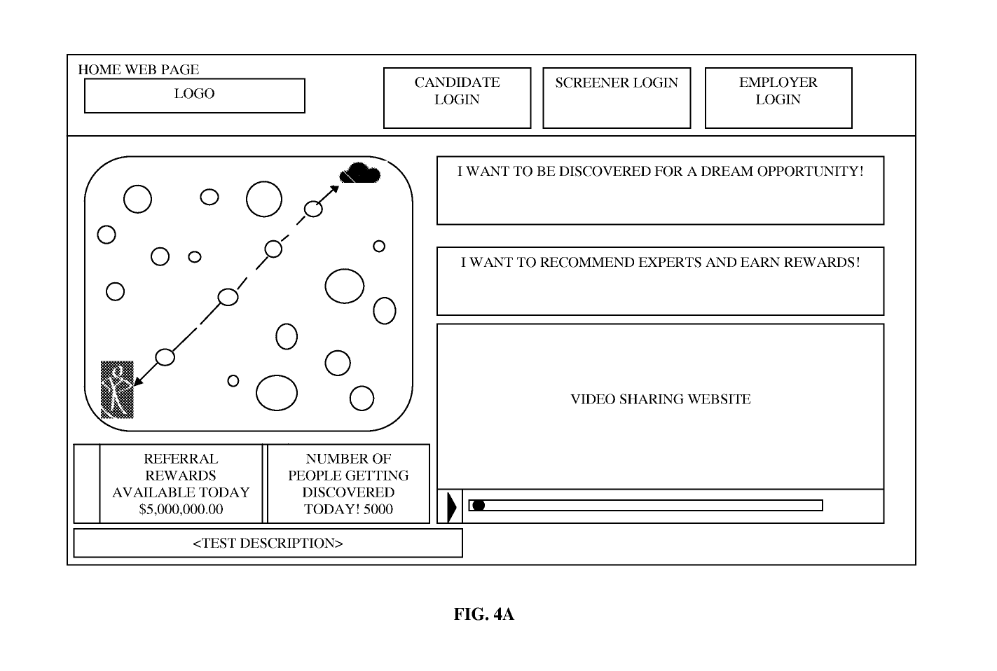

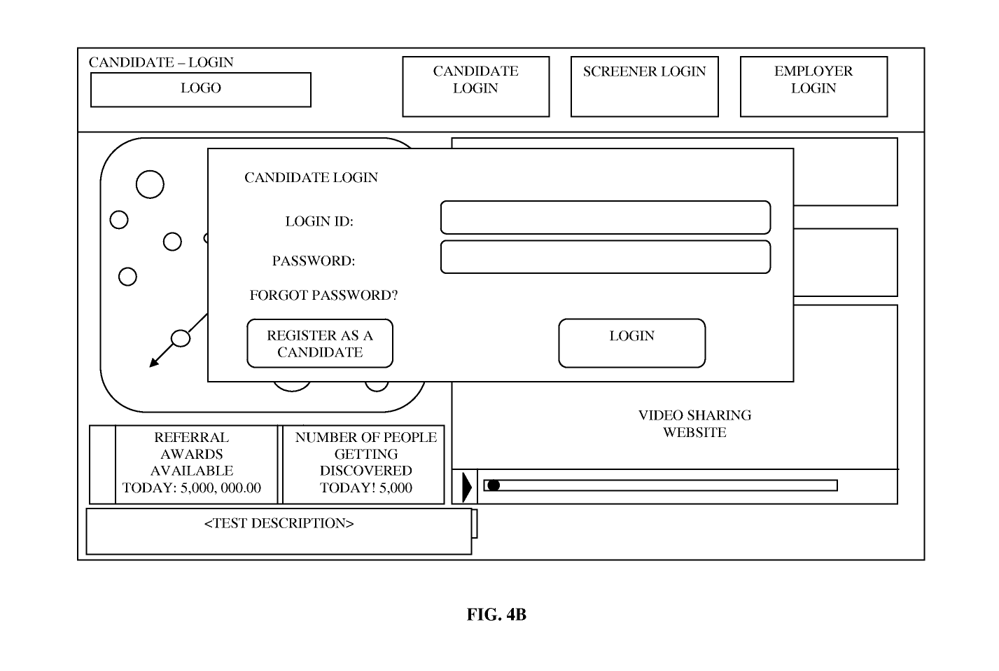

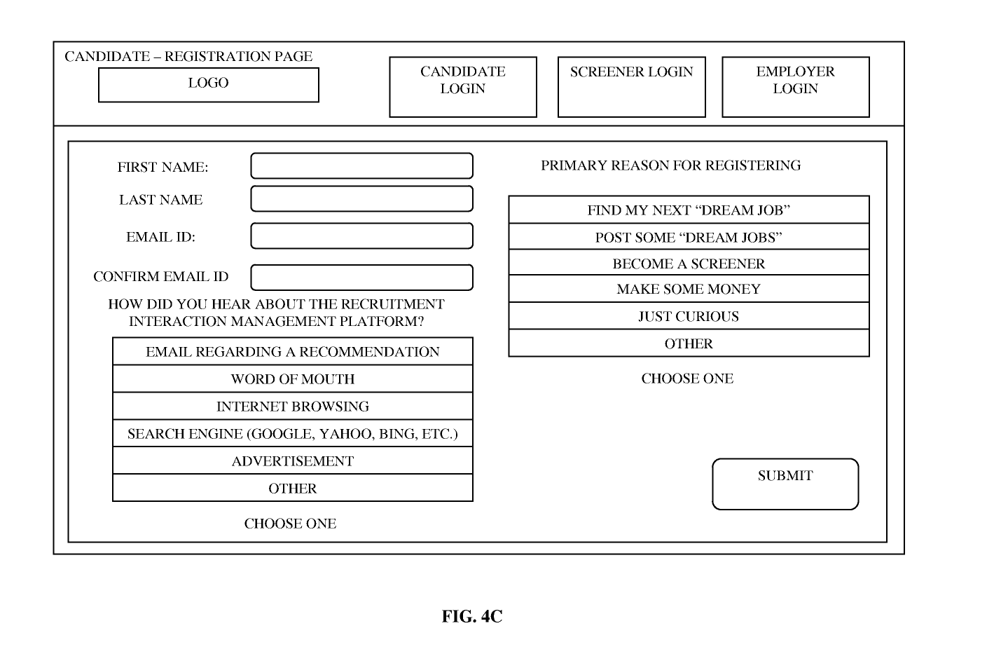

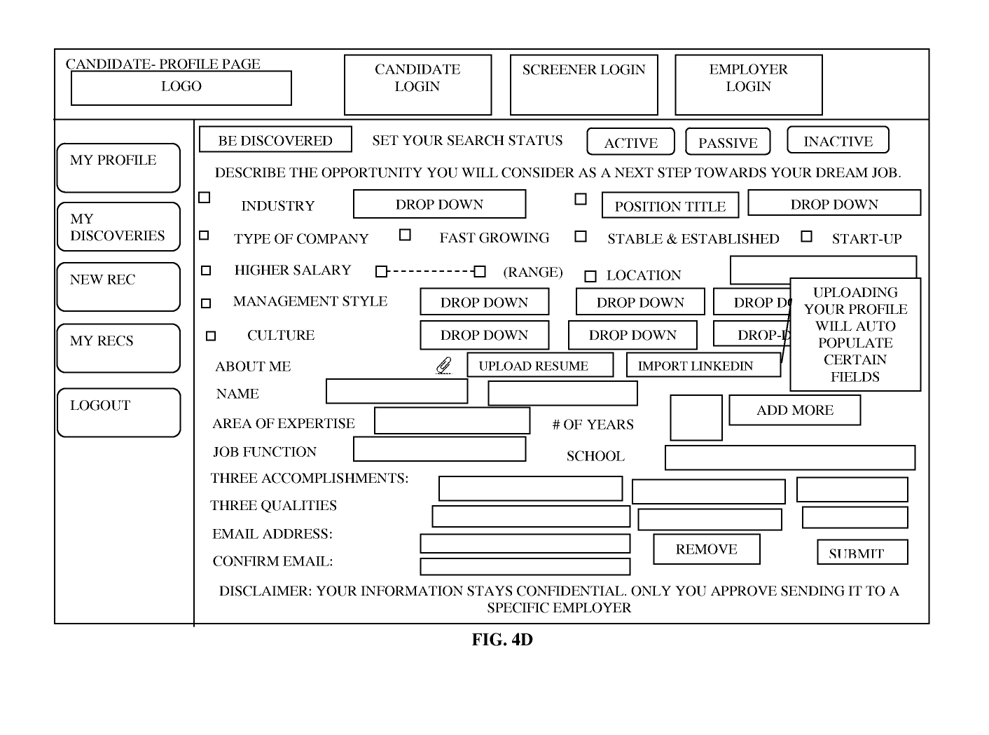

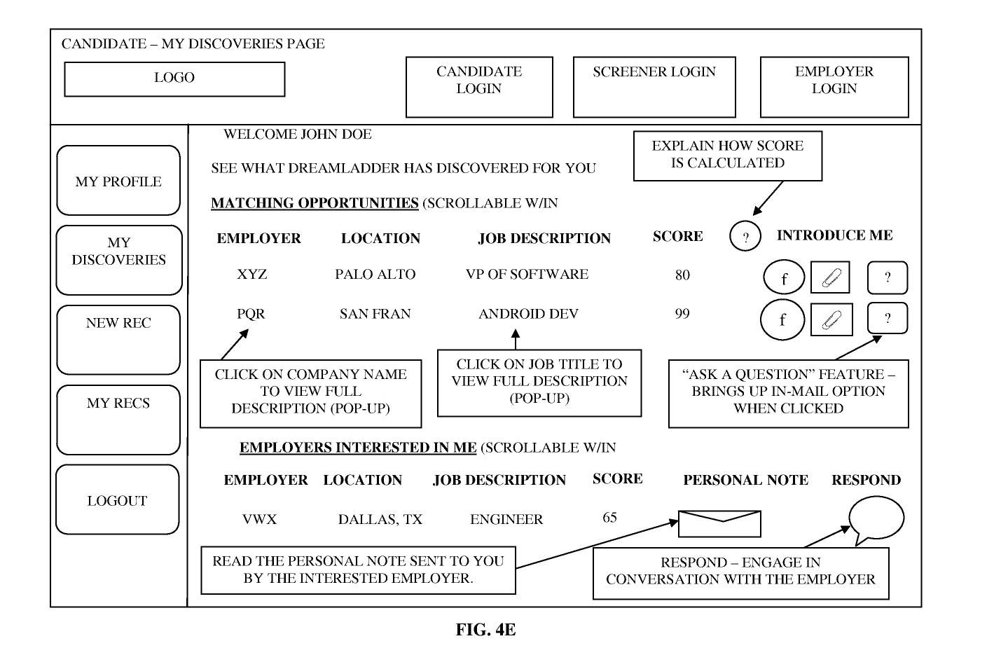

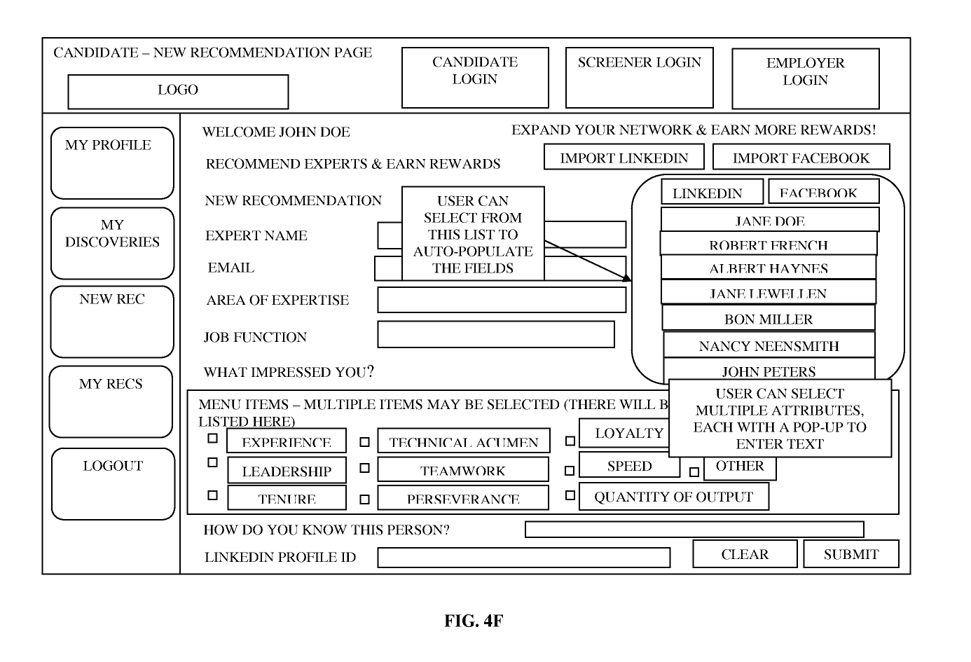

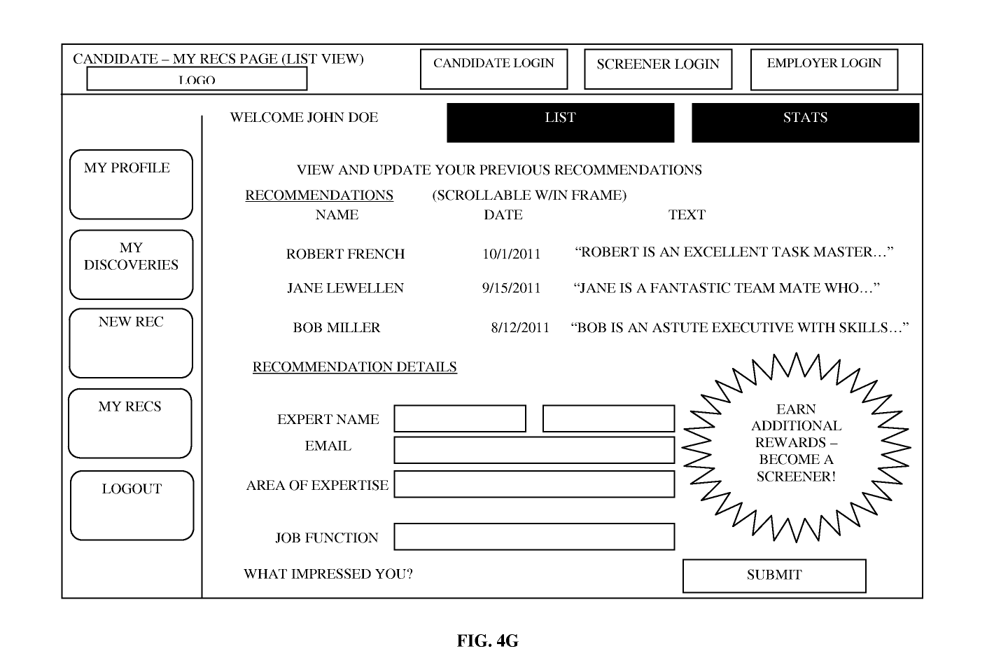

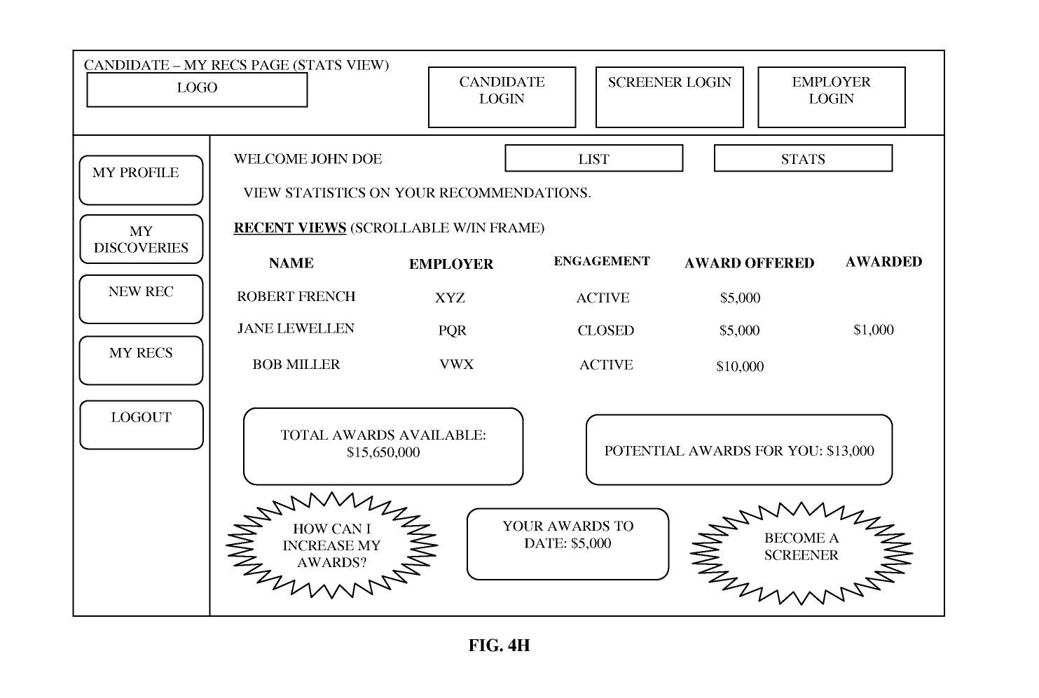

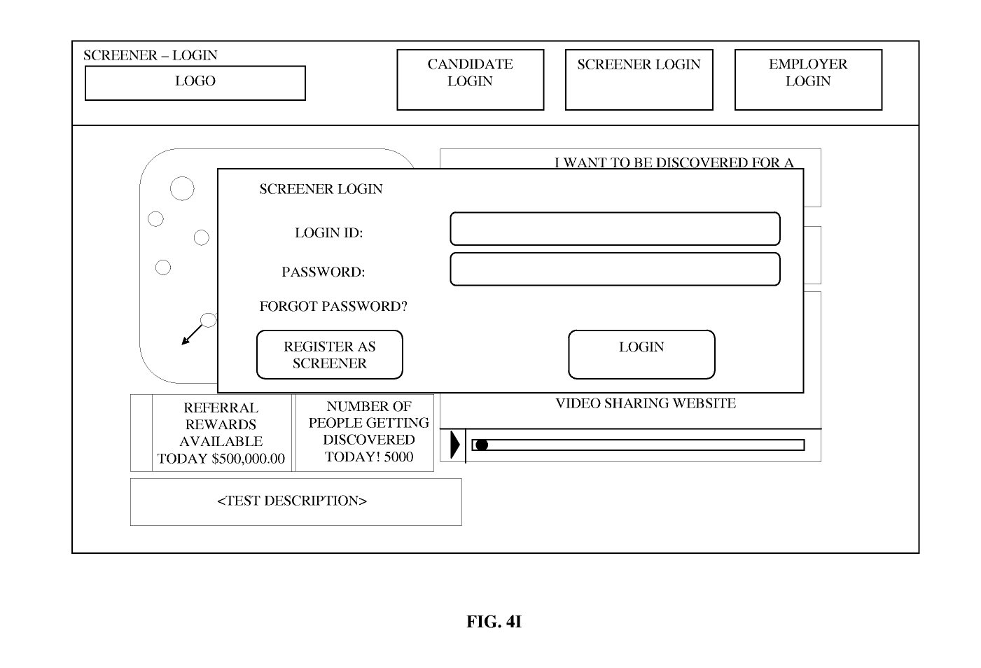

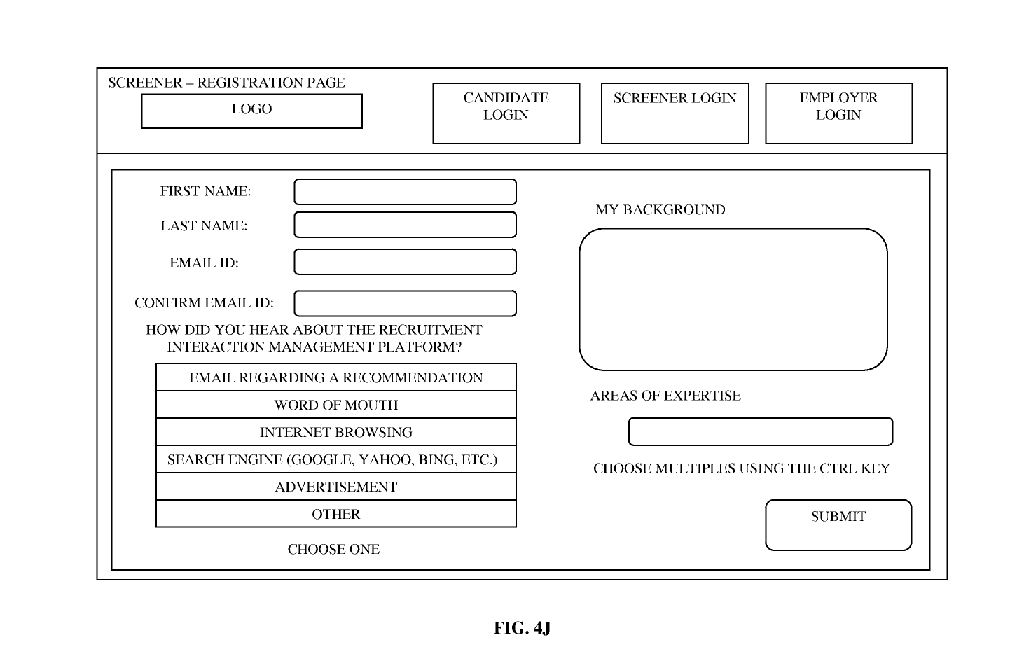

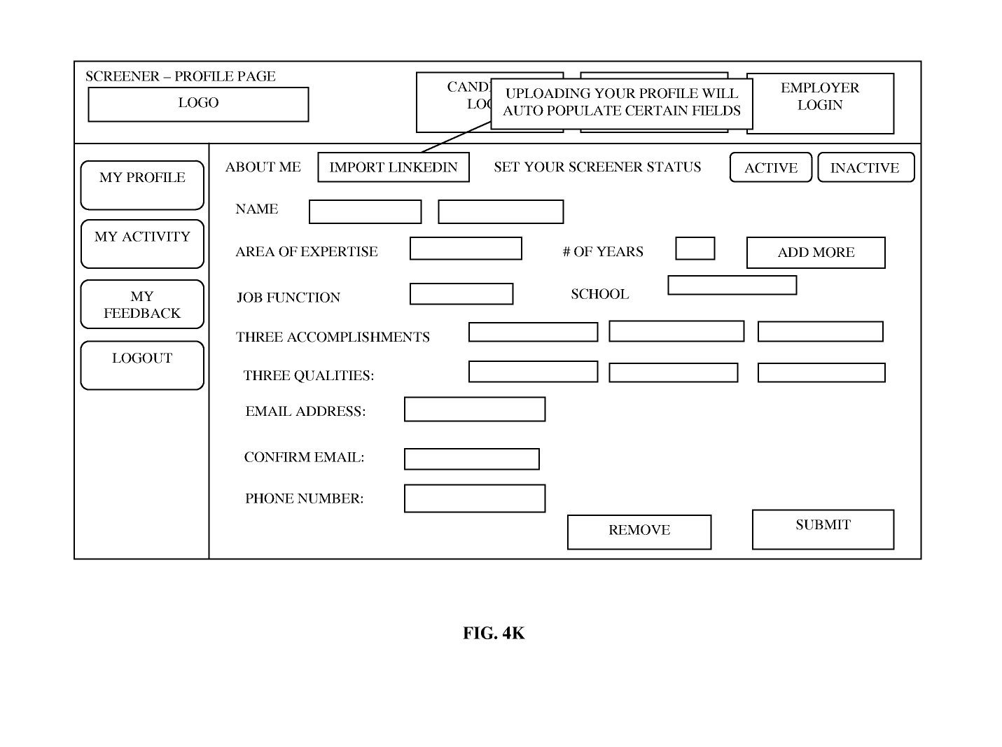

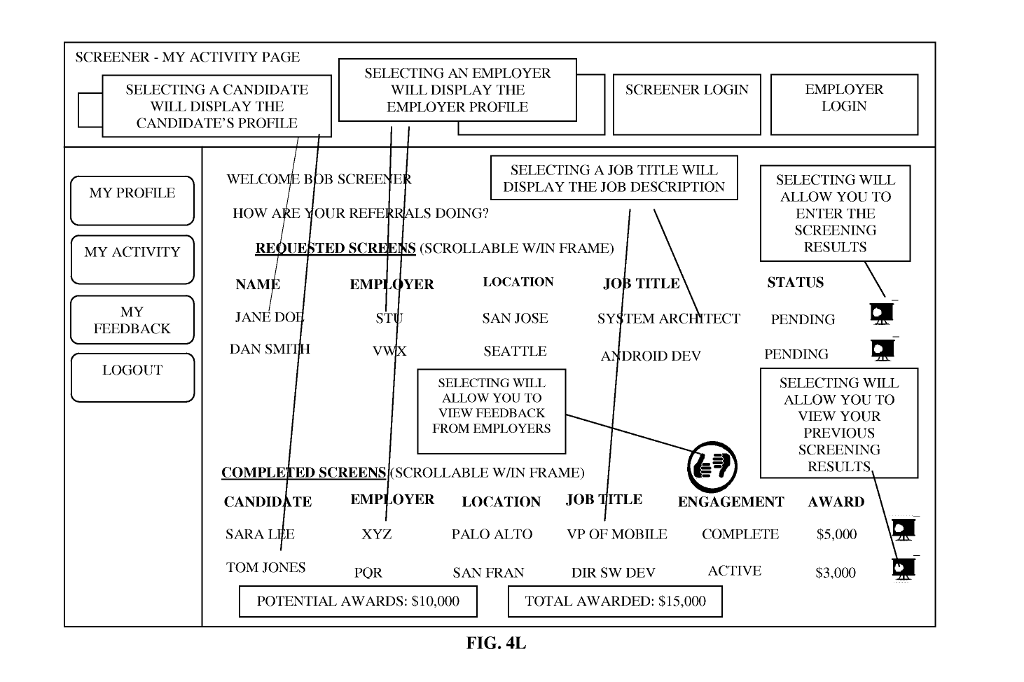

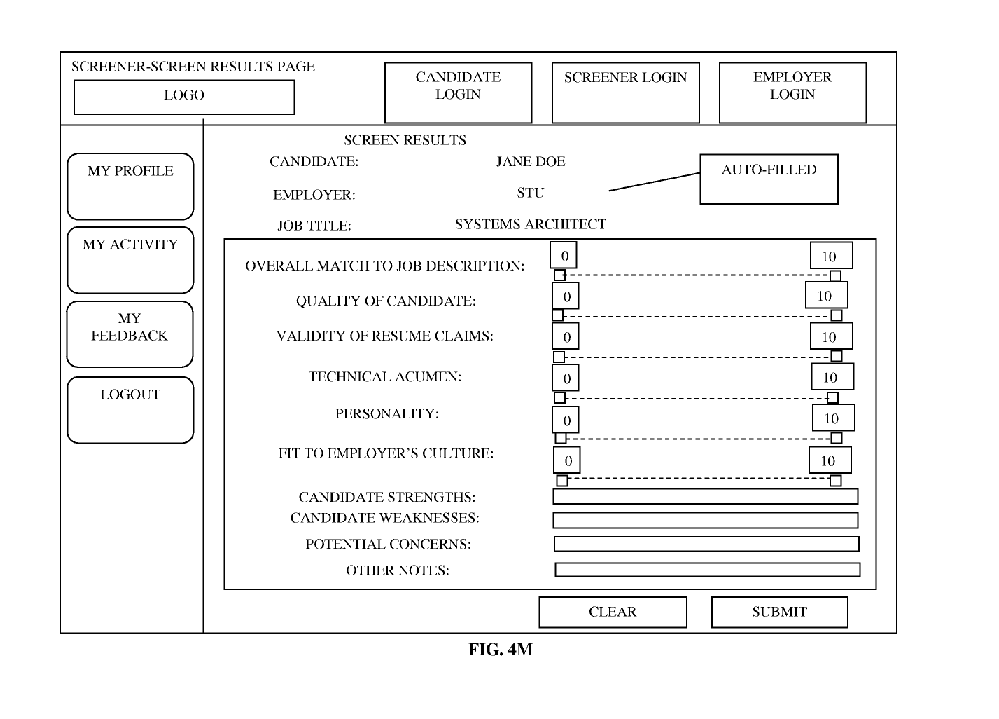

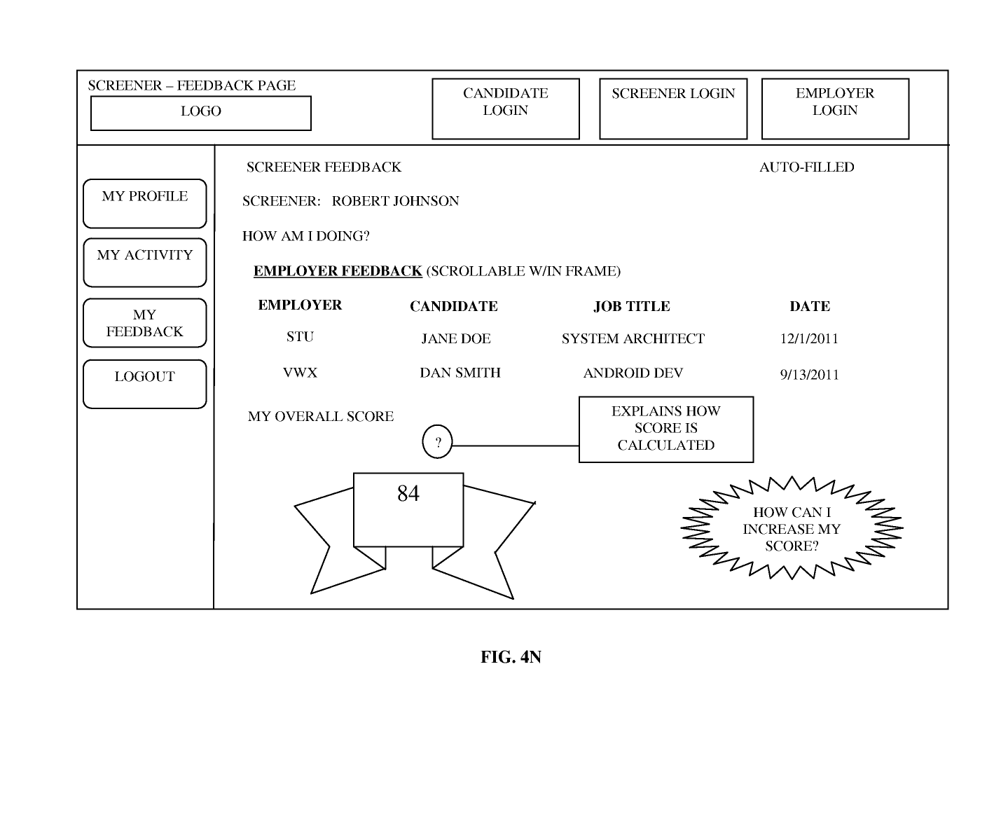

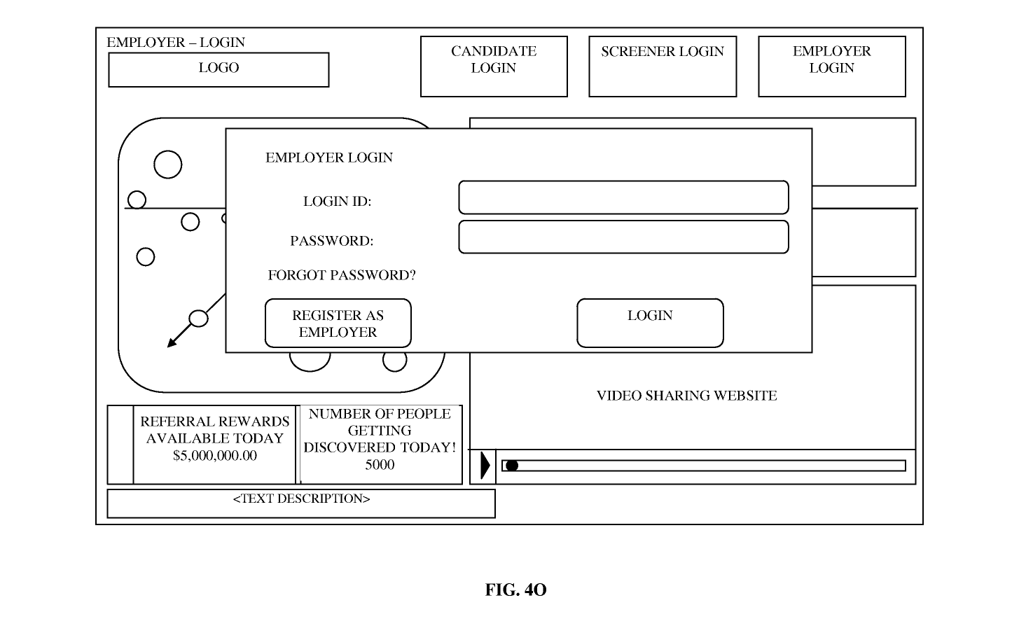

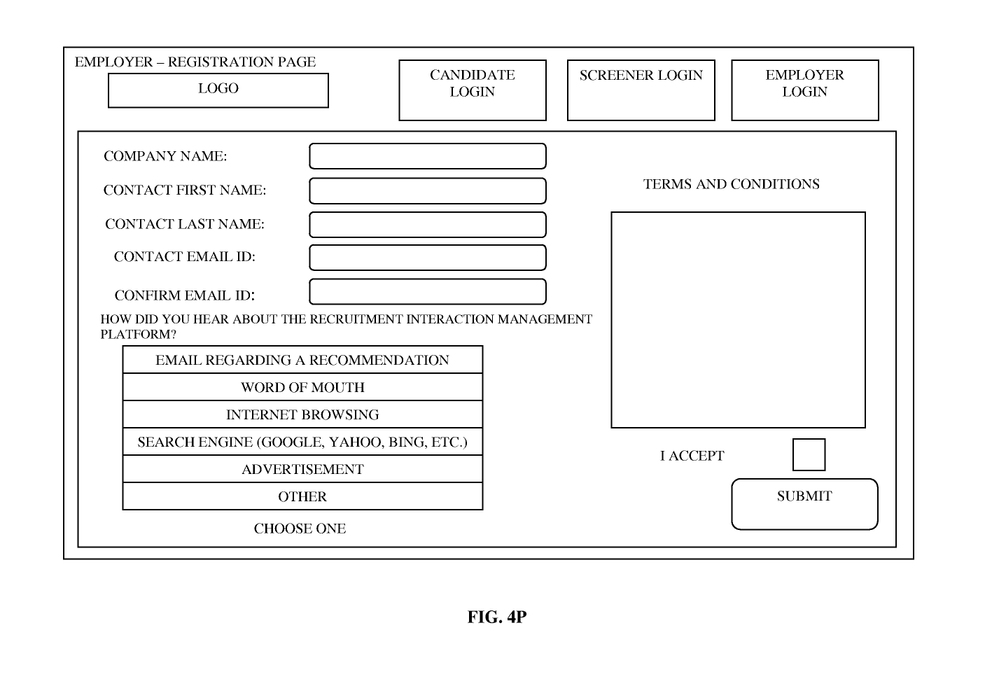

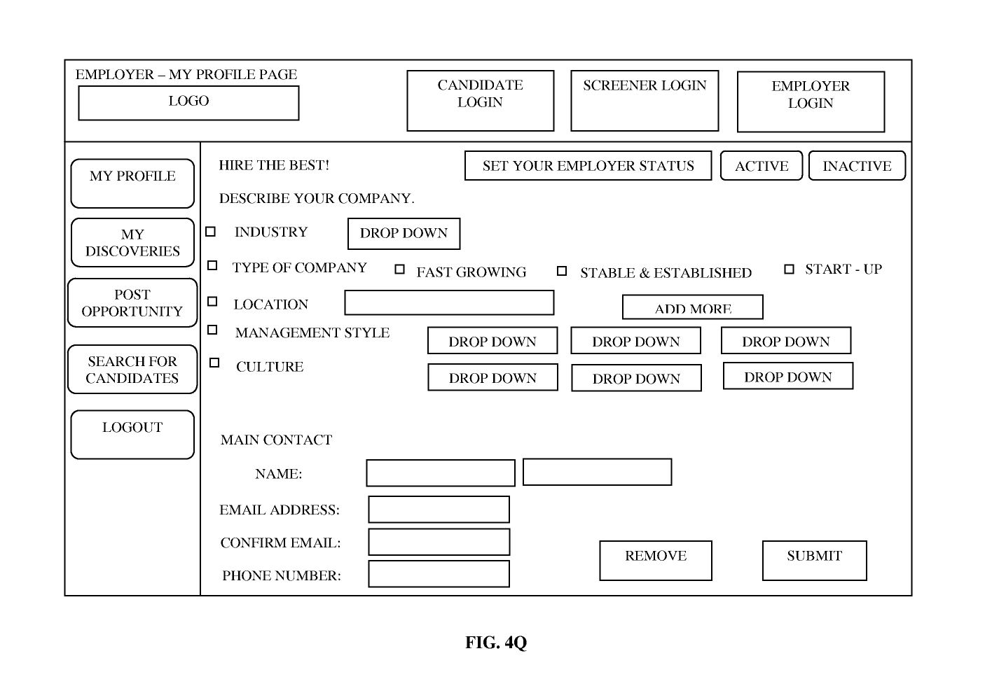

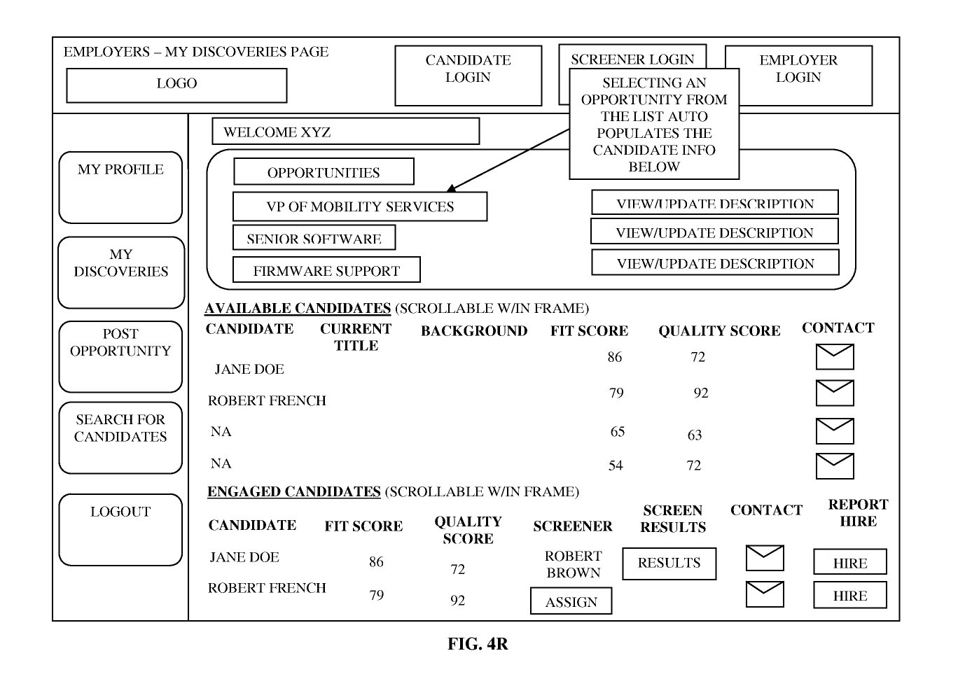

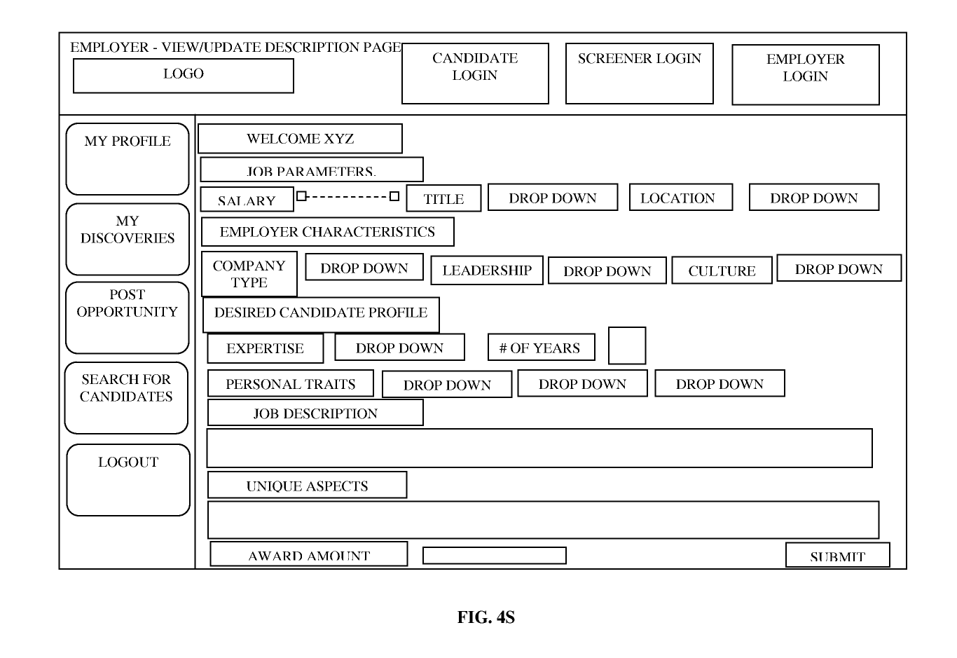

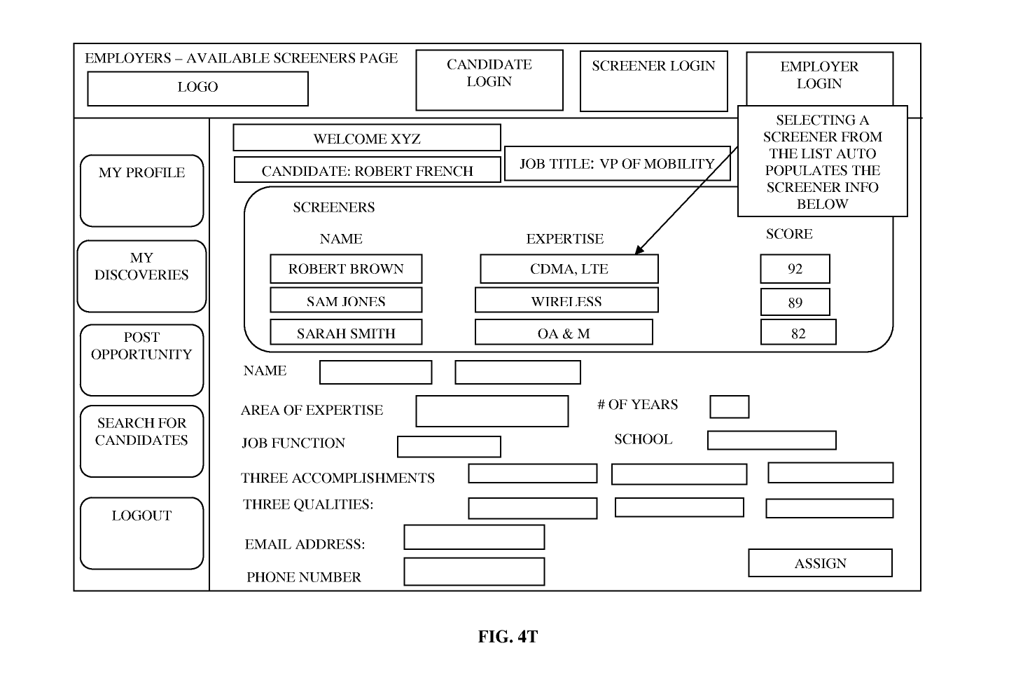

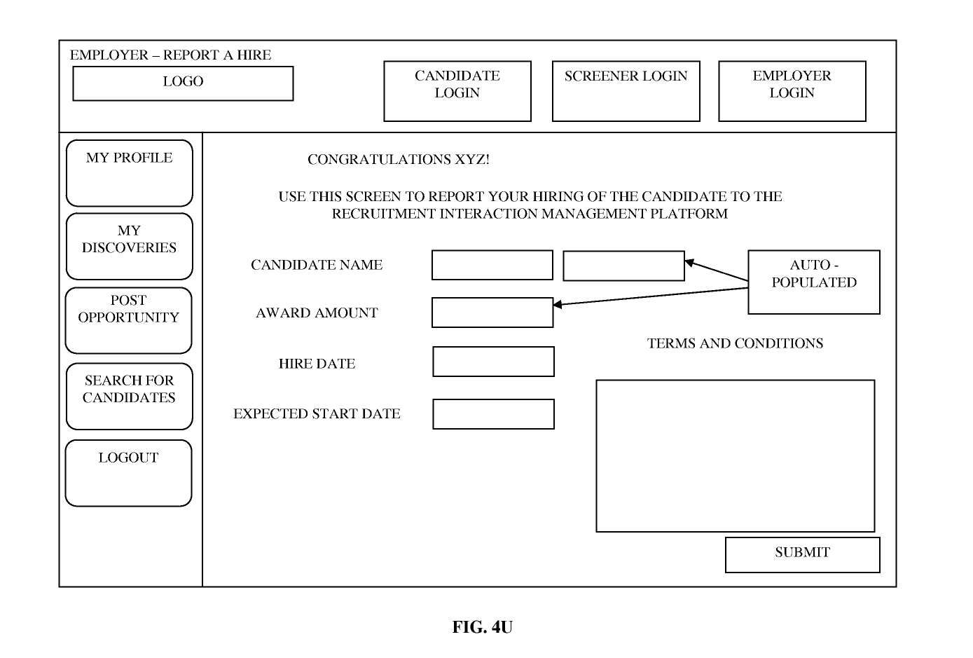

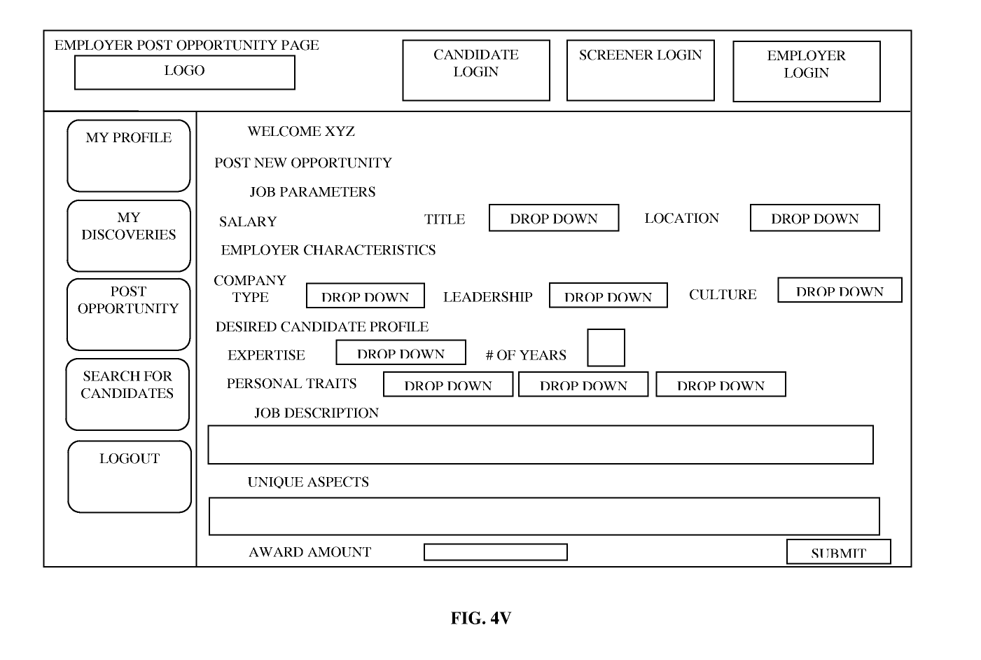

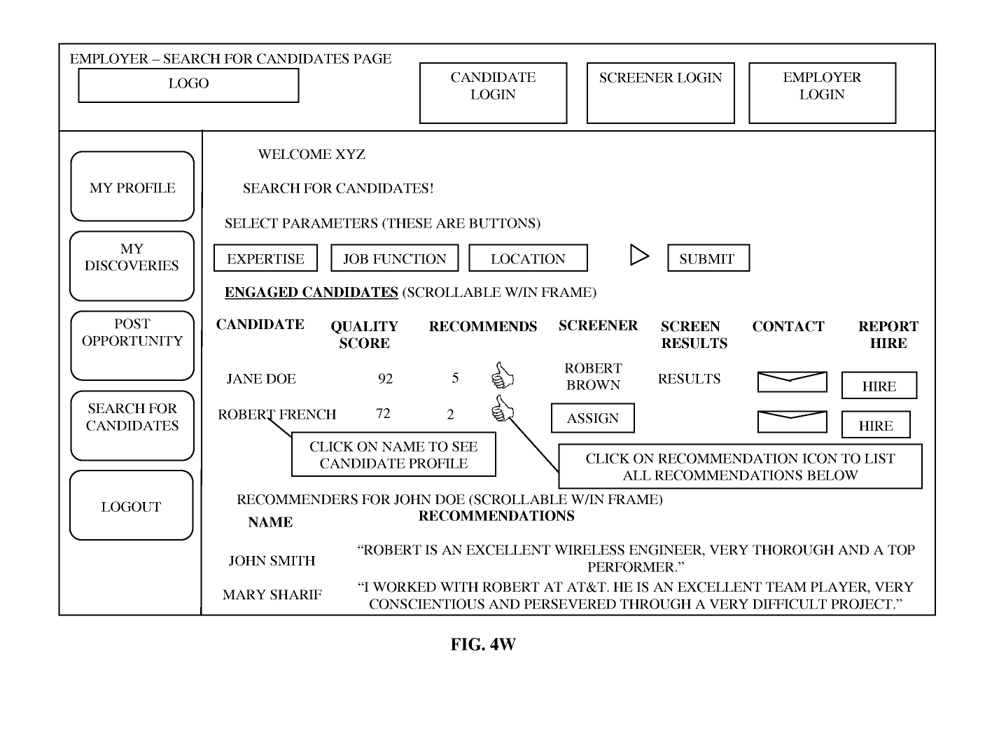

The recruitment interaction management platform generates and displays reports such as payment history and aggregated payment statistics reports on a home web page on the GUI as exemplarily illustrated in FIG. 4A. In an embodiment, the recruitment interaction management platform operates in collaboration with a third party taxation entity for issuing annual tax reports, etc., based on tax exemptions on the collected incentives. The implementation of the recruitment interaction management platform is made secure and hacker-proof by testing and certification by third parties. A security certification of the recruitment interaction management platform suggests that a hacker will not be able to break into the website of the recruitment interaction management platform and steal any information.

In an embodiment, the recruitment interaction management platform provides a web services layer for a native smart phone application for interaction between the smart phone application on a user's computing device and the recruitment interaction management platform via the network. For example, a mobile version of the recruitment interaction management platform is provided on a smart phone user's native smart phone.

Consider an example of managing recruitment interactions among multiple users associated with multiple roles, according to the computer implemented method and system disclosed herein. Consider, for example, that Tom is aware that Bill is a good Java programmer with particular skills in high performance web middleware using open source software components. Tom may know this because Bill is his friend, his neighbor, his relative, his office peer, his business acquaintance, or because he has heard of Bill's skills through other people he knows. Tom logs in to the recruitment interaction management platform and enters details of Bill's profile on the GUI based on his knowledge of Bill and creates a menu-driven recommendation for Bill on the GUI. Bill or other users may have entered Bill's profile in the recruitment interaction management platform already. Tom can add a new recommendation for Bill via the GUI. Tom can enter information in Bill's profile on the GUI or provide Bill with a recommendation, for example, by pasting into Bill's profile a pointer to Bill's web page on other social network sources such as Linkedin® or Facebook®. In an embodiment, the recruitment interaction management platform allows a user to connect to other social network sources, fetch Bill's web page on these social network sources, and copy Bill's information into Bill's profile on the recruitment interaction management platform.

Independently and in parallel or sometime in the future an organization XYZ, Inc., who may be looking to recruit a Java programmer with particular skills in high performance web middleware using open source software components, conducts a search for candidate profiles that match the recruiting requirement at the recruitment interaction management platform, and finds Bill's community-sourced profile and recommendations. The recruitment interaction management platform collects the successful recruitment fee also referred to as a “placement fee” that XYZ pays when XYZ hires Bill, and shares the fee with Tom and others in the community who participated in entering, correcting, screening, or enhancing Bill's profile and in providing recommendations to Bill. XYZ allocates the incentives based on the predetermined incentive allocation criteria. XYZ benefits from a large pool of potential candidates with rich, community-sourced profiles and recommendations at the recruitment interaction management platform. Tom and other contributors benefit through the incentives or monetary rewards they receive. The recruitment interaction management platform benefits from a share in the recruitment fee that XYZ pays to the recruitment interaction management platform.

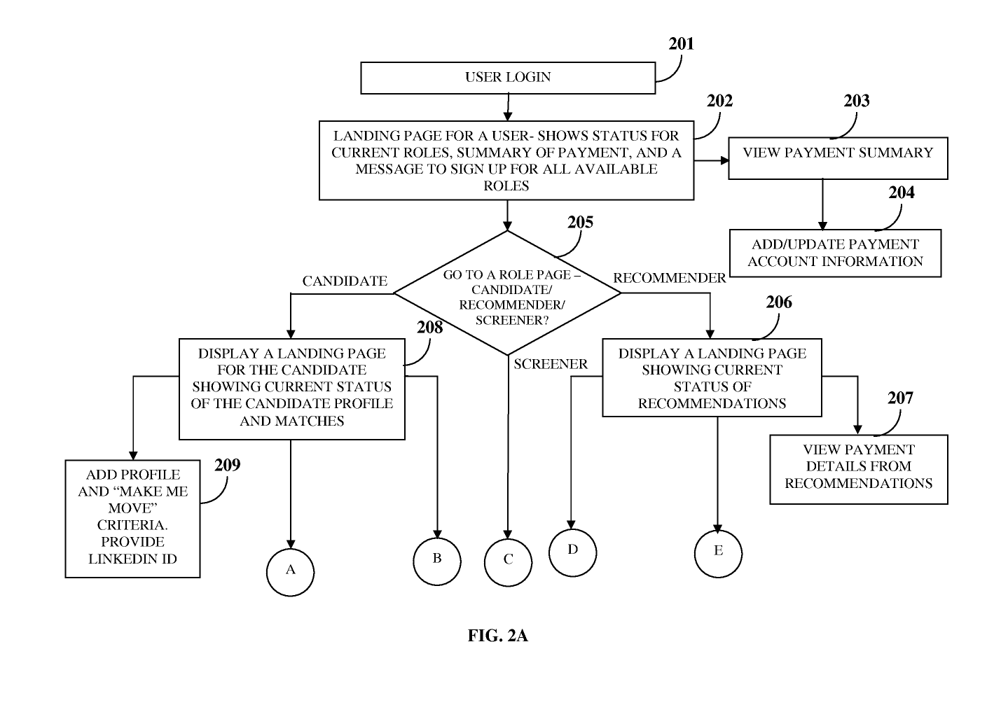

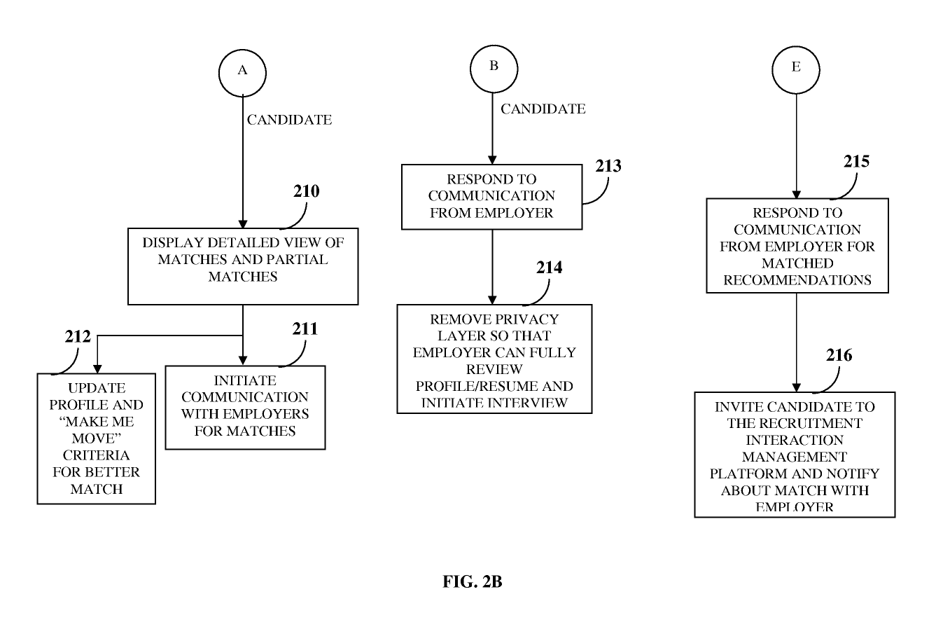

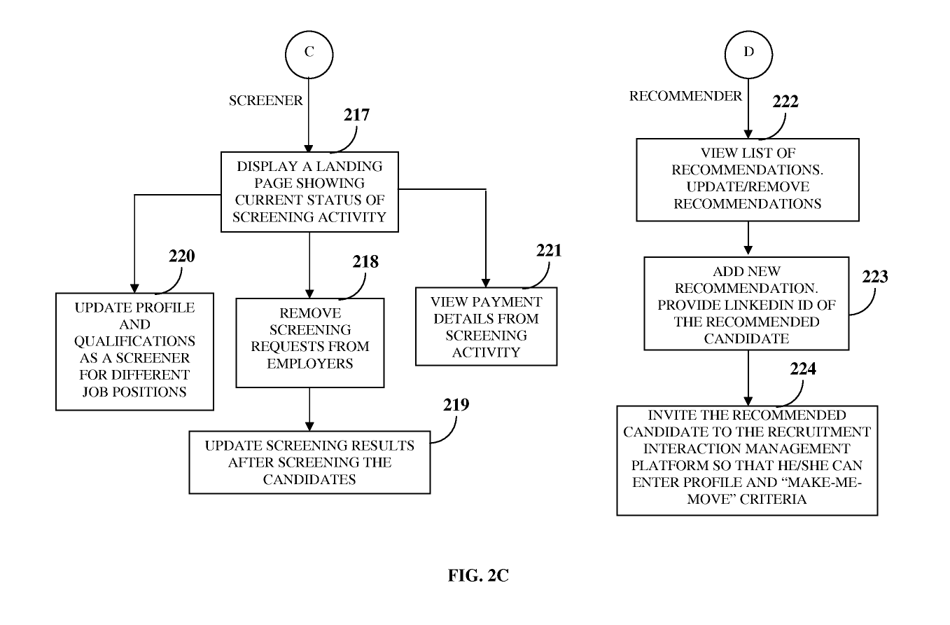

FIGS. 2A-2C exemplarily illustrate a flowchart comprising the steps for managing recruitment interactions, indicating the different roles that may be performed by a user of the recruitment interaction management platform. Consider an example where a registered user logs 201 into the recruitment interaction management platform. As exemplarily illustrated in FIG. 2A, the recruitment interaction management platform displays 202 a landing page, for example, a home web page on the graphical user interface (GUI) to the user, showing status and statistical data for the current roles performed by the user in the recruitment process, a summary of payments received by the user as incentives allocated by the recruitment interaction management platform, and a message to sign up for other available roles that the user has not yet considered. The statistical data comprises, for example, a number of candidates recommended by the user who have been selected for suggested job openings, a number of candidates who have been engaged for preliminary discussions by a recruiter herein referred to as an “employer”, etc. The user may view 203 a payment summary and add and/or update 204 his/her payment account information such as bank account details on the GUI.

The recruitment interaction management platform then determines 205 whether the user would like to enter a role page for the user to perform one of the roles, for example, a candidate role, a recommender role, a screener role, etc., that the user has selected. If the user clicks on the role page and selects the candidate role, the recruitment interaction management platform displays 208 a landing page for the candidate role, showing the current status of the candidate profile, that is, whether the user is active or passive, the number of matches between the candidate's profile and recruiting requirements received by the recruitment interaction management platform from recruiters or employers, and links for viewing detailed information on the candidate's profile and the matches. If the user clicks on a button to add profile information on the landing page, the recruitment interaction management platform provides an interface to allow the user to add 209 additional profile information, “make me move” criteria, and provide links to professional social network sources, for example, a Linkedin® account. The “make me move” criteria comprise, for example, the salary expectation of the user, a position title expectation, the preferred work location of the user, a field of interest, etc.

If the user clicks on the option to view detailed information on the matches between the user's candidate profile and the recruiting requirements, the recruitment interaction management platform displays 210 a detailed view of the matches, of partial matches with the recruiting requirements, etc., as exemplarily illustrated in FIG. 2B. Furthermore, based on the number of matches between the user's candidate profile and the recruiting requirements acquired by the recruitment interaction management platform, the user may decide to update 212 the candidate profile and “make me move” criteria for obtaining better matches. The recruitment interaction management platform provides an interface, for example, a private messaging interface that allows the user to initiate 211 a communication with the employers associated with the recruiting requirements that match the user's candidate profile. The recruitment interaction management platform displays an interface element, for example, a reply field, using which a user can respond 213 to a communication request received from a particular employer. The recruitment interaction management platform allows the user to modify the privacy settings by removing 214 a privacy layer so that the employer can fully review the user's profile and/or resume and initiate an interview with the user.

As exemplarily illustrated in FIG. 2C, if the user selects a screener role on the role page, the recruitment interaction management platform displays 217 a landing page showing the current status of the user's screening activity. The recruitment interaction management platform provides an interface that allows the screener to update 220 the screener profile and qualifications as a screener for screening candidates for different job positions. The user receives screening requests from different employers that have been forwarded to the user by the recruitment interaction management platform. When a particular screener has viewed the screening requests from an employer and has accepted the responsibility of screening candidates, the recruitment interaction management platform removes 218 the screening requests from the employers, since the screening requests have been accepted. The user can screen the profiles and resumes of the candidates and update 219 the screening results after the screening. The user can view 221 payment details related to incentives allocated to the user by the recruitment interaction management platform for performing screening activities, that is, for screening the resumes of the candidates for one or more employers.

As exemplarily illustrated in FIG. 2A, if the user selects a recommender role, the recruitment interaction management platform displays 206 a landing page showing the current status of recommendations provided by the recommender and messages received from one or more employers stating the matched recommendations. A user in a recommender role who recommends another candidate is herein referred to as a “recommender”. The recommender can view 207 payment details related to incentives acquired by the recommender for recommending, that is, for providing recommendations to candidates on the GUI. As exemplarily illustrated in FIG. 2C, the recommender may also view 222 a list of recommendations displayed by the recruitment interaction management platform on the GUI. Furthermore, the recruitment interaction management platform provides options on the GUI to allow the recommender to update and/or remove 222 the recommendations. After viewing the list of recommendations added by the recommender, the recommender may add 223 a new recommendation and provide, for example, a Linkedin® ID of the recommended candidate to the recruitment interaction management platform. Furthermore, the recruitment interaction management platform provides an invitation template that can be completed by the recommender for inviting 224 the recommended candidate to the recruitment interaction management platform so that the recommended candidate can enter profile information and “make me move” criteria.

If the recommender selects the option to view requests for communication with a particular employer, the recruitment interaction management platform displays the conversation threads already created as part of the communication with the employer or starts a new thread. As exemplarily illustrated in FIG. 2B, the recommender can respond 215 to communication, for example, a query on an amount of time that a recommender has known a particular candidate, received from an employer, for matched recommendations. The recommender can invite 216 the candidate associated with the matched recommendation to the recruitment interaction management platform and notify the candidate on the match with the recruiting requirement of the employer.

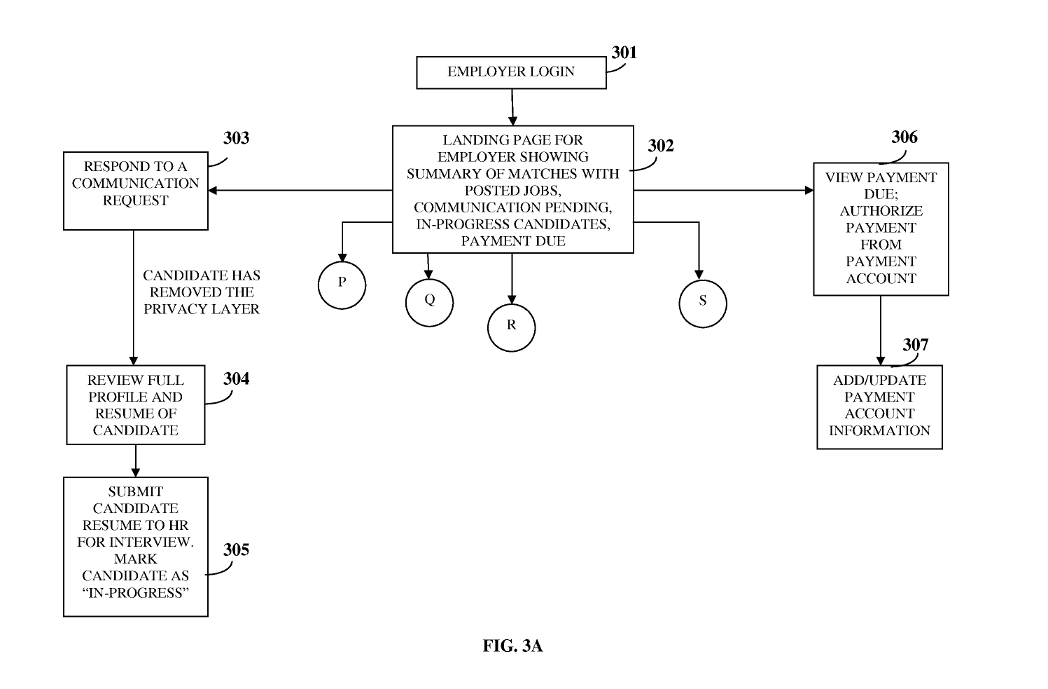

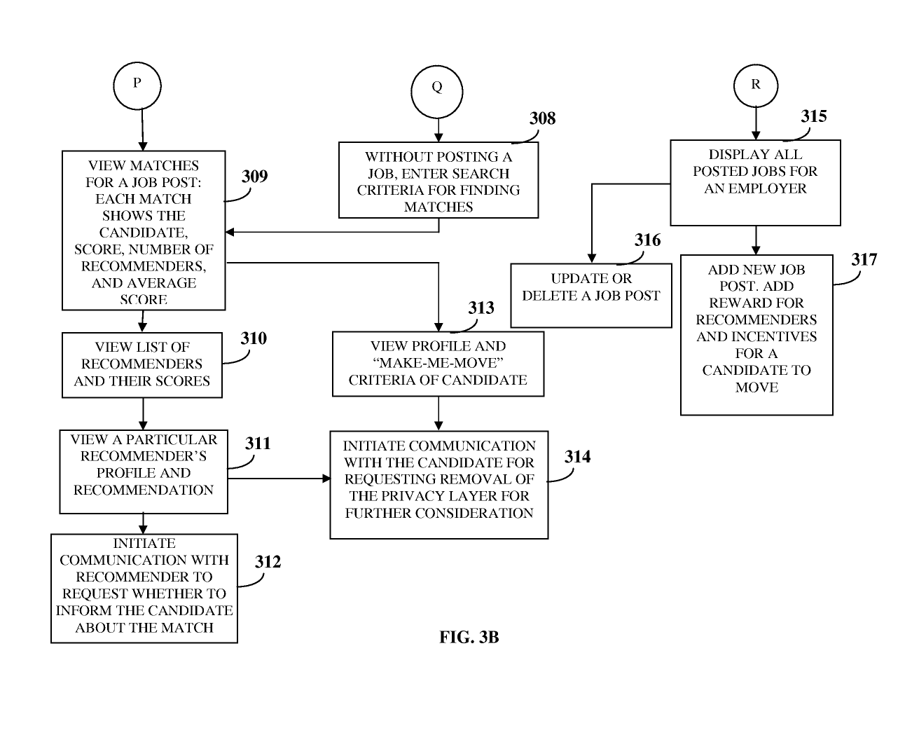

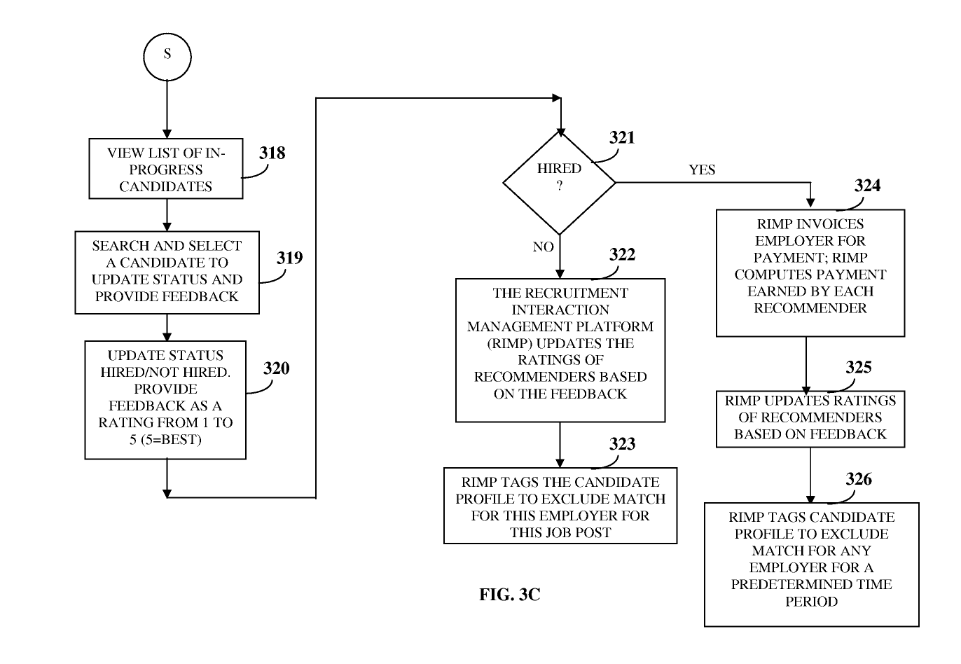

FIGS. 3A-3C exemplarily illustrate a flowchart comprising the steps performed by an employer or a recruiter registered with the recruitment interaction management platform (RIMP) during recruitment interactions with other users. As exemplarily illustrated in FIG. 3A, the employer logs 301 in to the recruitment interaction management platform. On logging in, the recruitment interaction management platform displays 302 a landing page for the employer, showing a summary of one or more matches with jobs posted by the employer, pending communication messages, the number of “in-progress” candidates, that is, the number of candidates who have been engaged by the employer but are yet to complete all the steps for recruitment, the payment due to the recruitment interaction management platform for recommenders or screeners responsible for recommending or screening a candidate selected by the employer, etc. The recruitment interaction management platform provides links to view and respond to each of the messages in detail on the graphical user interface (GUI).

Consider that the employer has first selected an option on the GUI to respond 303 to a communication request. The employer checks whether the contacted candidate has removed the privacy layer and if the privacy layer has been removed, the employer can review 304 the full or complete profile and resume of the candidate. The employer submits 305 the candidate's resume to an HR division for interview and marks the candidate as “in-progress”.

Consider that the employer then selects the option to view 309 matches for a job post as exemplarily illustrated in FIG. 3B. Each match displayed by the recruitment interaction management platform shows the profile information of the candidate, an evaluation score assigned to each recommender and the candidate, the number of recommenders who have recommended the candidate with the matching profile, and an average score of the candidate and each recommender. The employer may then view each recommender's profile and/or the candidate's profile on the GUI. The employer can view 310 a list of recommenders and their respective scores and ratings on the GUI. The employer can view 311 a particular recommender's profile and recommendation. The employer can also initiate 312 a communication with the recommender via a private messaging interface to request whether to inform the candidate about the match. Using another option provided to the employer by the recruitment interaction management platform on the GUI, the employer can view 313 the selected candidate's profile and the “make me move” criteria of the candidate. The employer can then initiate 314 communication with the candidate via a private messaging interface and request removal of the privacy layer for further consideration of the candidate for recruitment.

The recruitment interaction management platform allows the employer to search for candidates even without posting a job opening or a recruiting requirement. Without posting a job opening, the employer can enter 308 search criteria on the GUI for finding matches with a particular recruiting requirement. The recruitment interaction management platform generates a candidate list of candidates that match the search criteria and displays each of the matching candidate profiles, the number of recommenders recommending those candidates, etc., on the GUI for viewing 309 by the employer. Furthermore, the recruitment interaction management platform displays 315 a list of all the jobs posted by the employer on the GUI for the employer to review. On viewing the list of all the posted jobs, an employer may update or delete 316 a job post via the GUI. The employer may also add 317 a new job post, rewards for recommenders, and incentives for the candidate to move to a job posted by the employer.

As exemplarily illustrated in FIG. 3C, the employer can view 318 a list of in-progress candidates, on the GUI of the recruitment interaction management platform. The “in-progress” candidates are the candidates who are currently undergoing recruitment interactions with the employer for a recruiting requirement. The employer can search and select 319 a candidate via the GUI to update the status of recruitment, conduct an interview or a preliminary communication session, and provide feedback on the performance of the candidate to the recruitment interaction management platform. The recruitment interaction management platform updates 320 the status of the selected candidate as “hired” or “not hired” based on the inputs acquired from the employer. Furthermore, the employer can provide 320 feedback to the recruitment interaction management platform on the performance of the candidate as a rating from 1 to 5, where a score of 5 is the highest score and indicates that the performance of the candidate was exemplary. The recruitment interaction management platform determines 321 from the feedback whether the candidate was hired.

If the candidate was hired, the recruitment interaction management platform invoices 324 the employer for payment. The recruitment interaction management platform applies a payment algorithm to compute 324 the payment to be allocated to each of the recommenders who recommended the hired candidate. The recruitment interaction management platform updates 325 the ratings of the recommenders based on the feedback received from the employer. The recruitment interaction management platform tags 326 the successfully hired candidate's profile to exclude matches for other employers for a predetermined time period, since the candidate was recently hired and the employer has paid a recruitment fee for the successful recruitment of the candidate to the recruitment interaction management platform, and since it is prudent not to showcase this candidate to other employers for a suitable period of time. If the candidate was not hired, the recruitment interaction management platform updates 322 the ratings of the recommenders based on the feedback. For example, if a particular candidate has performed very poorly in an interview, the recruitment interaction management platform assigns a negative rating to the recommender who recommended the candidate. The recruitment interaction management platform tags 323 the candidate profile of the candidate to exclude a match for that particular employer for a particular skill set and position for the job post.

As exemplarily illustrated in FIG. 3A, the employer can also view 306 the payment due to the recommenders and screeners associated with the hired candidate on the GUI and authorize payment from the payment account of the employer. The employer can add and/or update 307 payment account information on the GUI.

FIGS. 4A-4W exemplarily illustrate screenshots of a graphical user interface (GUI) provided by the recruitment interaction management platform for managing recruitment interactions among multiple users associated with multiple roles. FIG. 4A exemplarily illustrates a screenshot of the GUI of the recruitment interaction management platform displaying a home web page provided by the recruitment interaction management platform. The recruitment interaction management platform enables a user to register with the recruitment interaction management platform if the user has not already registered, or login to the recruitment interaction management platform in a candidate role via a candidate login, in a screener role via a screener login, or in a recruiter role or an employer role via an employer login, using a user identifier and password. Furthermore, the home web page displays the incentives available to a user for recommending or referring another user on a particular day.

The recruitment interaction management platform provides unique login credentials for a user to access the recruitment interaction management platform. When the user logs in from the home web page using the unique login credentials, the recruitment interaction management platform displays a user specific landing page on the GUI that provides aggregated statistics for different roles for which the user has registered. For each role of the user, for example, a candidate role, a recommender role, a screener role, an employer role, a recruiter role, etc., the recruitment interaction management platform navigates to the role specific profile page from the landing page. Since each user can perform multiple roles, the recruitment interaction management platform allows profile variations based on each of the roles. For example, candidates have a “self profile”, recommenders have a “recommender's self profile” and one or more “recommendations”, screeners have a “screener's self profile”, employers have a “company's self profile” and one or more “job profiles”. By default, the recommender's self profile is visible to employers. The screener's self profile is also visible to the employers.

Consider an example where a user selects a candidate role. If a candidate has already registered with the recruitment interaction management platform, the user can login as a candidate to the recruitment interaction management platform as exemplarily illustrated in FIG. 4B. If the user wants to register as a candidate, the recruitment interaction management platform displays a candidate registration interface as exemplarily illustrated in FIG. 4C. The candidate registration interface comprises, for example, text boxes for entering the user's personal details such as a first name, a last name, and an electronic mail identifier (email ID). The candidate registration interface also requests the user to inform the recruitment interaction management platform on how the user learnt about the recruitment interaction management platform, the primary reason for registering with the recruitment interaction management platform, etc.

If the user has already registered with the recruitment interaction management platform as a candidate and logs in using the user login ID and password, the recruitment interaction management platform displays a candidate profile web page as exemplarily illustrated in FIG. 4D. A profile of a candidate created on the recruitment interaction management platform by the candidate himself/herself is herein referred to as “self profile”. The candidate profile web page displays options that allow a candidate to enter job expectation information and “make me move” criteria as defined, for example, by the industry, salary and compensation, work location, work environment, culture, etc., that attracts the candidate towards a job. The candidate profile web page also allows the candidate to enter other profile information, for example, area of expertise, accomplishments, qualities, etc. In an embodiment, the recruitment interaction management platform provides an application programming interface (API) to social network sources such as Linkedin® that allows the user to provide a Linkedin® ID in the self profile. The candidate web page allows the candidate to upload a resume, import Linkedin® profile information of the candidate into the recruitment interaction management platform, etc. The context sensitive interface elements on the GUI of the recruitment interaction management platform ensures that the uploading of the self profile by the candidate auto-populates certain fields of the profile information. The “My discoveries” web page of a candidate John Doe, exemplarily illustrated in FIG. 4E, displays the available job opportunities that match the candidate's profile. For example, the “My discoveries” web page displays information on the employers, job locations, and job descriptions that match the candidate's profile and expectations. The “My discoveries” web page also allows the candidate to understand how a score was calculated, to ask a question, to read a personal note sent to the candidate by the employer, to engage in a conversation on a private messaging interface with the employer, etc.

A candidate may also perform a recommender role. FIG. 4F exemplarily illustrates a screenshot of a web page that displays the interface elements provided on the GUI for entering a new recommendation by a recommender, John Doe. The recommender can enter personal details such as contact details, area of expertise, job function, etc., of another candidate whom the recommender wants to recommend. The recommender may also select a candidate from a list and click on buttons labeled “Linkedin” or “Facebook” provided on the GUI to allow the recruitment interaction management platform to automatically retrieve the Linkedin® ID or the Facebook® ID and the profile information of the selected candidate from these social network sources and autopopulate the corresponding candidate identity fields on the GUI. In an example, the recruitment interaction management platform retrieves the Linkedin® ID of the selected candidate and populates a field with the selected candidate's Linkedin® profile ID. Therefore, the recommendation may include a recommended candidate's Linkedin® ID. The recommender can add personal qualitative attributes of the candidate which impressed the recommender and specify how the recommender knows the candidate on the GUI. In an embodiment, the recruitment interaction management platform hides those fields of the recommendations that reveal the identity of a recommended candidate, until the candidate removes the privacy layer. The recommender can view a list of his recommendations stored by the recruitment interaction management platform on the GUI. A list of recommendations added by a recommender along with corresponding descriptions of the attributes of the candidate are exemplarily illustrated in FIG. 4G. The recruitment interaction management platform, for example, aggregates recommendations and the self profile provided by the candidate with the search key=Linkedin ID. The recruitment interaction management platform may also prompt a user to become a screener to earn additional incentives or rewards.

FIG. 4H exemplarily illustrates a screenshot of a “My recommendations” web page that displays the statistics collected by the recruitment interaction management platform on each of the recommendations provided by the recommender. The status of a transaction between an employer and each recommended candidate and the incentives allocated to the recommender based on the outcome of the transaction are exemplarily illustrated in FIG. 4H. For example, John Doe receives $1000 out of a total share of $5000 from the recruitment interaction management platform for recommending Jane Lewellen to employer PQR subsequent to her placement at PQR.

FIG. 4I exemplarily illustrates a screenshot of a login page for a screener role provided by the recruitment interaction management platform. A screener can login to the recruitment interaction management platform by providing the login ID and password if the screener has already registered with the recruitment interaction management platform, or can register with the recruitment interaction management platform. A screener registration interface for a screener is exemplarily illustrated in FIG. 4J. The screener registration interface comprises fields for entering, for example, a first name, a last name, and an email ID of the screener. The screener registration interface provides a drop down menu for selecting the areas of expertise applicable to the screener, and a window for entering a background description about the screener.

FIG. 4K exemplarily illustrates a screenshot of a profile web page provided by the recruitment interaction management platform for a screener after the screener has logged in to the recruitment interaction management platform. The profile web page provides fields for entering, for example, the name, area of expertise, number of years of experience in an area of expertise, accomplishments, qualities, contact details, etc., of the screener. Furthermore, when the screener clicks on an “Import LinkedIn” button provided on the profile web page, the recruitment interaction management platform imports the LinkedIn® profile information of the screener and auto-populates fields on the screener's profile web page. The screener can set the status as “active” or “passive” depending on whether the screener is currently available to perform screening of candidate profiles.

FIG. 4L exemplarily illustrates a screenshot of a “My activity” web page of a screener that displays the screened candidate profiles or profiles of candidates requested to be screened by the screener. The screening requests received by a screener Bob is exemplarily illustrated in FIG. 4L. The screener Bob can select a candidate on the web page for viewing the candidate profile, can select an employer on the web page for viewing the employer profile, or can select an associated job description, a work location, and a job title on the web page for viewing the screening request. An icon is displayed next to each screening request to allow the screener to enter the screening result. The status of each of the screening requests is set to pending until the screener Bob enters a screening result. The screener Bob can also view the completed screening requests, the results of the transactions between an employer and a screened candidate, and the incentives allocated to the screener for screening the candidate profile of the candidate who has been selected by the employer. Furthermore, the recruitment interaction management platform provides an option on the “My activity” web page for the screener to view the feedback on the screened candidate profiles from employers and also to view previous screening results. A screening results web page displays, for example, fields, text boxes, and other interface elements for allowing the screener to enter the evaluation of a candidate profile as a potential match to a recruiting requirement or a job description provided by the employer as exemplarily illustrated in FIG. 4M. For example, the screener can provide a rating between 1 and 10 to indicate the quality of the candidate in terms of technical skills, personality, an extent to which the candidate matches the work culture of the employer, strengths of the candidate, weaknesses of the candidate, validity of resume claims, concerns, etc.

FIG. 4N exemplarily illustrates a screenshot of a web page indicating the feedback received by a screener from an employer with reference to the screened candidates. Based on the feedback, the recruitment interaction management platform assigns a rating, for example, between 1 and 100 to the screener. In this example, the screener Robert Johnson receives an overall rating of 84 based on feedback from employers STU and VWX for screening Jane Doe and Dan Smith respectively.

FIG. 40 exemplarily illustrates a screenshot of a login web page provided by the recruitment interaction management platform for an employer role. If the employer needs to register with the recruitment interaction management platform, the recruitment interaction management platform displays an employer registration interface as exemplarily illustrated in FIG. 4P. The employer is provided with fields on the employer registration interface to enter the company name, contact details, etc. On registering with the recruitment interaction management platform, the employer is provided with a “My Profile” web page that allows the employer to enter a company description comprising details on the type of company, that is, whether the company is a fast growing company, a start up, etc., a geographical location of the company, management style, culture, contact details, etc., as exemplarily illustrated in FIG. 4Q.

FIG. 4R exemplarily illustrates a screenshot of a “My discoveries” web page that allows an employer to view candidates to be contacted or already contacted by the employer in connection with a particular recruiting requirement or job description. For example, the employer may select one or more opportunities from a sorted list of job profiles associated with the employer displayed on the “My discoveries” web page to view available candidates and their quality ratings or scores as assigned by the recruitment interaction management platform based on inputs from screeners and recommenders. The employer can also view the candidates engaged by the employer, the screening results provided by the screeners for the engaged candidates, contact information of the engaged candidates, and can click on the “hire” button to complete recruitment of the candidates.

FIG. 4S exemplarily illustrates a screenshot of a job description page to be updated by the employer indicating job parameters, employer characteristics, a desired candidate profile, the amount of incentives that the employer is willing to pay, etc. FIG. 4T exemplarily illustrates a screenshot of a web page indicating the screeners available to the employer for screening the candidates. The web page exemplarily illustrated in FIG. 4T, displays the name of the screeners, area of expertise, number of years of experience of the screener, their assigned scores, etc. FIG. 4U exemplarily illustrates a screenshot of a web page that allows an employer to report the recruitment of a candidate to the recruitment interaction management platform. The report comprises fields for entering the candidate name, incentive, that is, the award amount, the hire date for the candidate, and the expected start date of the candidate.

FIG. 4V exemplarily illustrates a “post opportunity” web page displayed to the employer for providing a job description without indicating an actual job opening. FIG. 4W exemplarily illustrates a web page indicating the results of a search performed for an employer by the recruitment interaction management platform based on the match between the candidate profiles registered with the recruitment interaction management platform and the opportunities posted by the employer. The web page exemplarily illustrated in FIG. 4W, displays a list of engaged candidates, their quality scores, their recommendations, their screening results, etc.

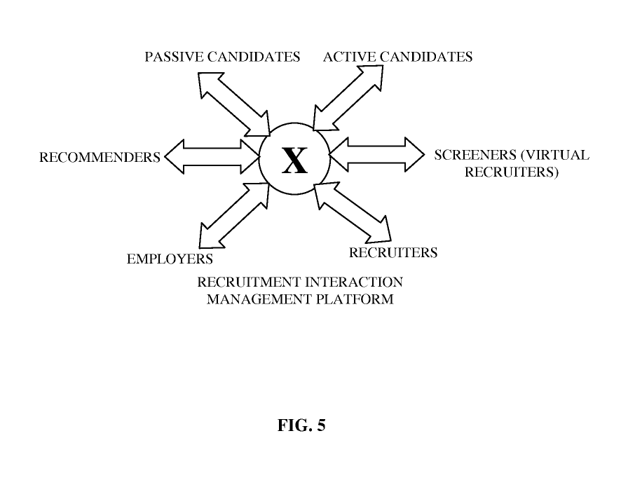

FIG. 5 exemplarily illustrates a schematic diagram showing multiple users that can perform recruitment interactions via the recruitment interaction management platform. The recruitment interaction management platform is configured as a web-based recruiting exchange and is, for example, a web 3.0 platform that brings together candidates, employers, and value-adding third parties such as recommenders and screeners. The screeners are called virtual recruiters. The recruiters are considered representatives of employees and therefore are considered as employers in the exchange. As exemplarily illustrated in FIG. 5, the recruitment interaction management platform acts as an intermediary entity that allows communication between different users associated with a recruitment process. The recruitment interaction management platform acts an exchange that routes messages and notifications across multiple users.

The recruitment interaction management platform serves as a larger exchange than a conventional job board and a typical social network source, where the conventional job board may serve as a first type of an exchange that enables communication among active candidates, that is, candidates actively looking for a new job, employers, and recruiters, and where the social network source may serve as a second exchange that involves communication among active candidates, passive candidates, that is, candidates eligible for a job, but who may not be actively looking for a new job, recruiters, and employers. The recruitment interactions on the social network source comprise, for example, providing recommendations by recommenders, tracking changes to profile information, notifying recruiters, etc.

Moreover, the recruitment interaction management platform provides application programming interfaces (APIs) for automatically retrieving profile information and recruitment advisory information from conventional job boards and social network sources. The recruitment interaction management platform further allows recommenders to provide recommendations on one or more candidates who may or may not be a part of the exchange. The recruitment interaction management platform further enables screeners to screen candidates based on their resumes and candidate profiles. The recruitment interaction management platform therefore interlinks active candidates, passive candidates, recommenders, screeners, recruiters, and employers, to actively interact with one another through messaging interfaces set up by the recruitment interaction management platform. Furthermore, each user can take up multiple roles based on which the interactions with other entities in the exchange varies correspondingly.

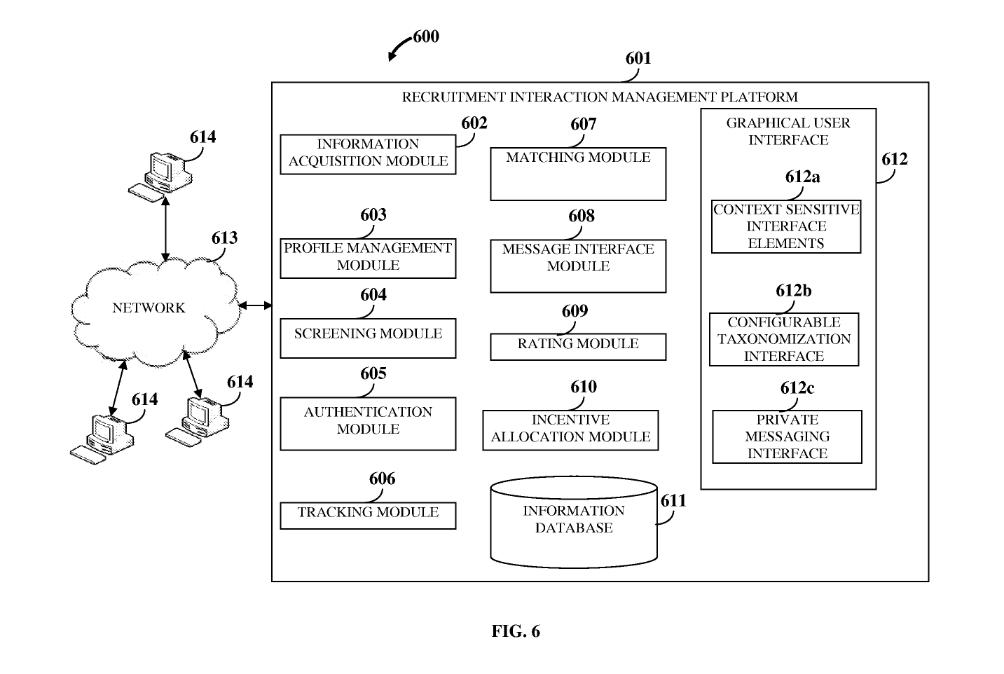

FIG. 6 exemplarily illustrates a computer implemented system 600 for managing recruitment interactions among multiple users associated with multiple roles. The computer implemented system 600 disclosed herein is referred to as a “recruitment interaction management system”. The computer implemented system 600 disclosed herein provides the recruitment interaction management platform 601 accessible to multiple users, for example, candidates, recruiters, recommenders, screeners, etc., via a network 613. The network 613 is, for example, the internet, an intranet, a local area network, a wide area network, a communication network implementing WiFi® of the Wireless Ethernet Compatibility Alliance, Inc., a cellular network, a mobile communication network, etc. The recruitment interaction management platform 601 comprises at least one processor configured to execute modules 602, 603, 604, 605, 606, 607, 608, 609, 610, and 611 of the recruitment interaction management platform 601 for managing recruitment interactions among the users. The recruitment interaction management platform 601 is, for example, hosted on a server or a network of servers that is accessible to the users via the network 613. The users may login to the recruitment interaction management platform 601 using their respective computing devices 614 via the network 613. The computing devices 614 are, for example, desktop computers, laptops, tablet computing devices, smart phones, personal digital assistants, mobile devices, etc. In an embodiment, the recruitment interaction management platform 601 is, for example, a web application.

The recruitment interaction management platform 601 comprises a graphical user interface (GUI) 612, an information acquisition module 602, a profile management module 603, a matching module 607, a rating module 609, an incentive allocation module 610, an authentication module 605, a message interface module 608, a screening module 604, a tracking module 606, and a scalable information database 611. The information acquisition module 602 acquires profile information from each of the users via the GUI 612 as disclosed in the detailed description of FIG. 1. The acquired profile information is associated with the roles to be performed by each of the users on the recruitment interaction management platform 601. In an embodiment, the GUI 612 comprises one or more context sensitive interface elements 612a that display contextual information based on preliminary inputs received from each of the users. The information acquisition module 602 also acquires recruitment advisory information from one or more users via the GUI 612 based on the roles of each of the users and/or one or more first external sources via the network 613 as disclosed in the detailed description of FIG. 1. For example, the information acquisition module 602 acquires user expectation information from the candidates, recruiting requirements and feedback from the recruiters, recommendations from the recommenders, screening results from the screeners, etc. The authentication module 605 verifies authenticity of the acquired recruitment advisory information.

The profile management module 603 creates one or more candidate profiles for the candidates using the recruitment advisory information and/or the acquired profile information. The profile management module 603 creates candidate profiles that are template driven, user generated, and structured. The GUI 612 of the recruitment interaction management platform 601 further comprises a configurable taxonomization interface 612b for dynamically acquiring taxonomies from the users for classifying the created candidate profiles of the candidates. The profile management module 603 configures user adjustable privacy settings for providing selective access of the acquired profile information of each of the users to other users and for maintaining anonymity during the recruitment interactions. The profile management module 603, in communication with the information acquisition module 602, utilizes the acquired recruitment advisory information for creating development programs and performance programs within an organization and for performing internal recruitment interactions within the organization.

The screening module 604 of the recruitment interaction management platform 601 acquires requests from the recruiters for screening one or more of the candidates via the GUI 612. The screening module 604 automatically assigns the acquired requests for screening to one or more screeners. The screening module 604 displays aggregated results of the screening received from the screeners to the recruiters on the GUI 612.

The matching module 607 matches the created candidate profiles with a recruiting requirement acquired from the users, for example, the recruiters via the GUI 612 and/or one or more second external sources via the network 613 based on matching criteria to generate a sorted candidate list in a priority order, that matches the recruiting requirement. The matching module 607 processes recommendations, screening results, and user expectation information extracted from the recruitment advisory information, and extracts the candidate profiles corresponding to the processed recommendations, the screening results, and the user expectation information. Furthermore, the matching module 607 sorts the extracted candidate profiles based on predefined categories as disclosed in the detailed description of FIG. 1.

The message interface module 608 provides a private messaging interface 612c for exchanging messages between a user and another user in one or more of multiple communication modes, without revealing the identification information of the users during the exchange. The private messaging interface 612c provided by the message interface module 608 allows users to take part in one or more transactions with each other. The message interface module 608 groups the exchanged messages of the other user for unified access by a user. The message interface module 608 initiates the exchange of the messages between the users via the private messaging interface 612c on successful matching of the user expectation information extracted from the acquired requirement advisory information with the recruiting requirement.

The rating module 609 dynamically assigns a rating to each of the users based on the roles associated with each of the users, the acquired profile information, an outcome of a transaction performed between one or more recruiters and one or more candidates from the generated candidate list, and predetermined rating criteria associated with the roles. In an embodiment, the rating module 609 assigns weights to profiles of each of the users based on the roles and weighting criteria. The rating module 609 computes the rating for each of the users based on the assigned weights. In an embodiment, the tracking module 606 tracks the outcome of the transaction between the recruiters and the candidates for a predetermined time period. The incentive allocation module 610, in communication with the tracking module 606, allocates the incentives to one or more recommenders and one or more screeners who have recommended and screened the candidates respectively, for each successful outcome of the transaction between the recruiters and the candidates.

The incentive allocation module 610 allocates incentives to each of the users based on the roles, the assigned rating, and predetermined incentive allocation criteria. In an embodiment, the incentive allocation module 610 collects incentives from the recruiters and/or the employers and performs allocation of the collected incentives to the users who provide the recruitment advisory information. The incentive allocation module 610, in communication with the authentication module 605, allocates incentives to the users, for example, the recommenders, the screeners, etc., based on the authenticity of the acquired recruitment advisory information.

The scalable information database 611 of the recruitment interaction management platform 601 implements load balancing, caching, and/or database scaling for optimally storing the acquired profile information, the created candidate profiles, and the recruitment advisory information. The information database 611 allows the recruitment interaction management platform 601 to support a large number of user accounts and employer accounts. The content in the information database 611 is structured to allow machine friendly searching, reasoning, and combing functions.

Consider an example where the recruitment interaction management platform 601 is designed initially to support a hundred thousand users. However, by selecting load sharing hardware and efficient software components, the recruitment interaction management platform 601 can support ten million users without any disruptive redesign. The recruitment interaction management platform 601 employs a split architecture that supports load balancers in front of web servers and application servers. Furthermore, the recruitment interaction management platform 601 uses a scalable structured query language (SQL) database and database caching to further enhance the scalability of the recruitment interaction management platform 601.

Furthermore, in an embodiment, the information database 611 is a part of a relational database management system that structures the acquired profile information, the acquired recruitment advisory information, the generated lists of selected candidate profiles, the user expectation information or the “make me move” criteria, that is, the employment profile preferred by a candidate, etc. Each aggregation of the recruitment related information associated with each of the users is, for example, stored in data entity tables in the information database 611. An individual element of the aggregated recruitment related information associated with each of the users is herein referred to a “data element”. The data elements stored in the information database 611 of the recruitment interaction management platform 601 comprise, for example, a name and contact information of a user, a Linkedin® ID of the user, a geographical location of interest, an area of expertise such as programming in Java® of Oracle Corporation, a current job profile such as a developer, a tester, a manager, an executive, etc., key accomplishments related to work, recent information that can impress a company or an organization, personality traits that may be menu-driven, a portable document format (PDF) document copy of the resume, “make me move” criteria that attracts a candidate to a new job, where the “make me move” criteria comprise a promotion, financial benefits such as a desired salary, a bonus program, stock options offered to employees, etc., a type of company such as a start-up company, a mid-sized company, a large established company, etc., an expected work location, etc.

Furthermore, the profile management module 603 allows each of the candidates to create more than one candidate profile. By default, a candidate's profile is private to protect the identity of the candidate. The fields of the candidate profile that are thus hidden comprise, for example, name, contact information, a Linkedin® ID, a PDF copy of the candidate's resume, a financial aspect of the “make me move criteria”, etc.

The recruitment interaction management platform 601 leaves one or more fields of the profile information open, for example, a geographical location of interest, an expertise area of the user, key accomplishments of the user, personality traits of the user, and “make me move” criteria excluding the financial benefits expected by the users. By leaving these fields of the profile information open, the recruitment interaction management platform 601 ensures that even when the identity of the candidate is not revealed, an employer may pursue further communication with a candidate based on a study of the open fields of the candidate profile. When a candidate then opens the privacy layer, the candidate profile is tagged with the list of employers for which the candidate profile is now open.

The data elements related to a recommender's profile comprise, for example, name and contact information of the recommender, a Linkedin® ID of the recommender, an area of expertise such as Java® programming, a job function such as a developer, a tester, a manager, an executive, etc., key accomplishments of the recommender, recent activities carried out by the recommender that can impress a customer, personality traits of the recommender, etc. The fields of the recommender's profile are menu-driven.

The data elements related to a recommendation comprise, for example, a name and contact information including the geographical location of the recommended candidate, a Linkedin® ID of the candidate, an expertise area such as software, manufacturing, etc., and a job function such as a developer, a tester, a manager, an executive, etc., for whom the recommendation is provided, professional skills for which a recommendation was provided such as Java®, Ruby on Rails® of David Heinemeier Hans son, etc., key accomplishments of the candidate being recommended, personality traits of the candidate, etc.

The data elements associated with an employer profile comprise, for example, a name of the company, contact information of the company, uniform resource locator (URL) links to the company website, messages for prospective employees such as “why one should work for the employer”, etc. The data elements associated with a recruiting requirement formulated, for example, in the form of a job posting comprise an area of expertise such as Java® programming, a job function such as a developer, a tester, a manager, an executive, etc., personality traits that are, for example, menu-driven, “make you move” criteria that can allure a candidate to a new job, such as the title, financial benefits such as the desired salary, bonus programs, stock options, etc., a type of company such as a start-up company, a mid-size company, a large company, etc., a geographical location of the company, etc.

In an embodiment, the recruitment interaction management platform 601 is configured to be hosted on a cloud computing platform. The recruitment interaction management platform 601 employs a cloud computing platform provided, for example, by Amazon® of Amazon Technologies, Inc., or Google App Engine™ of Google, Inc., Windows® Azure® of Microsoft Corporation, Rackspace® of Rackspace US, Inc., etc. The recruitment interaction management platform 601 employs application platforms that are specific to Ruby if implementation is performed using Ruby.

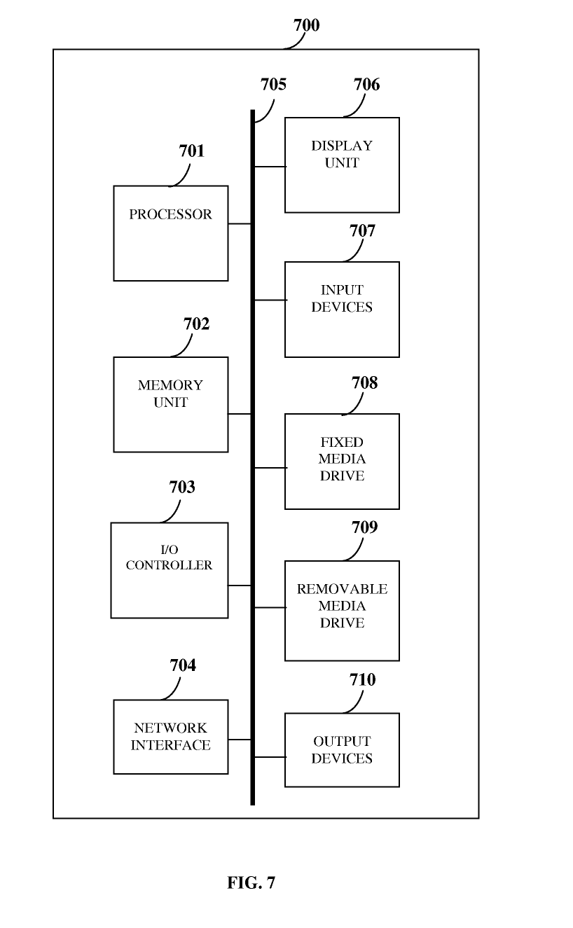

In an example, the recruitment interaction management platform 601 employs a solution stack of free, open source software, a combination of Linux®, Apache, MySQL, and PHP (LAMP), a browser scripting language such as AJAX, a server scripting language such as hypertext preprocessor (PHP), MySQL database, etc., for implementing computer program codes disclosed in the detailed description of FIG. 7, for managing recruitment interactions among users associated with multiple roles.

FIG. 7 exemplarily illustrates the architecture of a computer system 700 employed by the recruitment interaction management platform 601 for managing recruitment interactions among multiple users associated with multiple roles. The recruitment interaction management platform 601 of the computer implemented system 600 exemplarily illustrated in FIG. 6 employs the architecture of the computer system 700 exemplarily illustrated in FIG. 7.

The recruitment interaction management platform 601 communicates with the computing devices 614 of each of the users, for example, candidates, recommenders, screeners, employers, recruiters, etc., registered with the recruitment interaction management platform 601 via a network 613, for example, a short range network or a long range network. The network 613 is, for example, the internet, a local area network, a wide area network, a wireless network, a mobile communication network, etc. The computer system 700 comprises, for example, a processor 701, a memory unit 702 for storing programs and data, an input/output (I/O) controller 703, a network interface 704, a data bus 705, a display unit 706, input devices 707, a fixed media drive 708, a removable media drive 709 for receiving removable media, output devices 710, etc.

The processor 701 is an electronic circuit that executes computer programs. The memory unit 702 is used for storing programs, applications, and data. For example, the information acquisition module 602, the profile management module 603, the matching module 607, the rating module 609, the incentive allocation module 610, the authentication module 605, the message interface module 608, the screening module 604, the tracking module 606, etc., of the recruitment interaction management platform 601 are stored in the memory unit 702 of the computer system 700 of the recruitment interaction management platform 601. The memory unit 702 is, for example, a random access memory (RAM) or another type of dynamic storage device that stores information and instructions for execution by the processor 701. The memory unit 702 also stores temporary variables and other intermediate information used during execution of the instructions by the processor 701. The computer system 700 further comprises a read only memory (ROM) or another type of static storage device that stores static information and instructions for the processor 701.

The network interface 704 enables connection of the computer system 700 to the network 613. For example, the recruitment interaction management platform 601 connects to the network 613 via the network interface 704. The network interface 704 comprises, for example, an infrared (IR) interface, an interface implementing WiFi® of the Wireless Ethernet Compatibility Alliance, Inc., a universal serial bus (USB) interface, a local area network (LAN) interface, a wide area network (WAN) interface, etc. The I/O controller 703 controls input actions and output actions performed by the recruitment interaction management platform 601. The data bus 705 permits communications between the modules, for example, 602, 603, 604, 605, 606, 607, 608, 609, 610, 611, etc., of the recruitment interaction management platform 601.

The display unit 706 of the recruitment interaction management platform 601, via the graphical user interface (GUI) 612, displays information, display interfaces, user interface elements such as text fields, checkboxes, text boxes, windows, etc., for allowing a candidate to enter profile information, for allowing an employer, a recruiter, a recommender, or a screener to enter the recruitment advisory information comprising the recruiting requirement, the menu-driven recommendations, the screening results, etc., for allowing viewing of screening reports and lists of candidate profiles that match a particular recruiting requirement, etc. The input devices 707 are used for inputting data into the computer system 700. The candidates, the recommenders, the screeners, the recruiters, and the employers use input devices to provide inputs to the recruitment interaction management platform 601. For example, a user may enter profile information, enter recommendations for a candidate, upload a resume of a particular candidate, upload screening results or reports in response to the screening requests received from an employer, etc., using the input devices. The input devices 707 are, for example, a keyboard such as an alphanumeric keyboard, a joystick, a pointing device such as a computer mouse, a touch pad, a light pen, etc.

The output devices 710 output the results of operations performed by the recruitment interaction management platform 601. For example, the recruitment interaction management platform 601 transmits notifications on the incentives allocated to each of the recommenders, the screeners, etc., associated with the outcome of a particular transaction, etc., using the output devices 710. The recruitment interaction management platform 601 displays the generated candidate list of candidate profiles that match the recruiting requirement to the employer, a rating assigned to each of the recommenders, the screeners, etc., using the output devices 710.

Computer applications and programs are used for operating the computer system 700. The programs are loaded onto the fixed media drive 708 and into the memory unit 702 of the computer system 700 via the removable media drive 709. In an embodiment, the computer applications and programs may be loaded directly via the network 613. Computer applications and programs are executed by double clicking a related icon displayed on the display unit 706 using one of the input devices 707.

The computer system 700 employs an operating system for performing multiple tasks. The operating system is responsible for management and coordination of activities and sharing of resources of the computer system 700. The operating system further manages security of the computer system 700, peripheral devices connected to the computer system 700, and network connections. The operating system employed on the computer system 700 recognizes, for example, inputs provided by the users using one of the input devices 707, the output display, files, and directories stored locally on the fixed media drive 708, for example, a hard drive. The operating system on the computer system 700 executes different programs using the processor 701. The processor 701 retrieves instructions for executing the modules, for example, 602, 603, 604, 605, 606, 607, 608, 609, 610, 611, etc., of the recruitment interaction management platform 601 from the memory unit 702. A program counter determines the location of the instructions in the memory unit 702. The program counter stores a number that identifies the current position in the program of each of the modules, for example, 602, 603, 604, 605, 606, 607, 608, 609, 610, 611, etc., of the recruitment interaction management platform 601.

The instructions fetched by the processor 701 from the memory unit 702 after being processed are decoded. The instructions are stored in an instruction register in the processor 701. After processing and decoding, the processor 701 executes the instructions. For example, the information acquisition module 602 defines instructions for acquiring profile information from each of the users via the GUI 612 of the recruitment interaction management platform 601. The information acquisition module 602 defines instructions for acquiring recruitment advisory information from one or more users via the GUI 612 based on the roles of each of the users and/or one or more the first external sources via the network 613. The authentication module 605 defines instructions for verifying authenticity of the acquired recruitment advisory information. The profile management module 603 defines instructions for creating one or more candidate profiles for the candidates using the acquired recruitment advisory information and/or the acquired profile information. The profile management module 603 defines instructions for configuring user adjustable privacy settings for providing selective access of the acquired profile information of each of the users to other users and for maintaining anonymity during the recruitment interactions.

The screening module 604 defines instructions for acquiring requests for screening one or more candidates via the GUI 612. Furthermore, the screening module 604 defines instructions for automatically assigning the acquired requests for screening to one or more screeners among the users, and for displaying aggregated results of the screening received from the screeners to the recruiters on the GUI 612.

The matching module 607 defines instructions for matching the created candidate profiles with the recruiting requirement acquired from one or more of the users via the GUI 612 and/or one or more second external sources via the network 613 based on matching criteria to generate a sorted candidate list in priority order that matches the recruiting requirement. Furthermore, the matching module 607 defines instructions for processing recommendations, screening results, and user expectation information extracted from the recruitment advisory information. The matching module 607 defines instructions for extracting the candidate profiles corresponding to the processed recommendations, the screening results, and the user expectation information, and for sorting the extracted candidate profiles based on predefined categories.

The message interface module 608 defines instructions for providing a private messaging interface 612c for exchanging messages between a user and another user in one or more of multiple communication modes, where the identification information of the users is not revealed during the exchange. The message interface module 608 defines instructions for initiating the exchange of the messages between a user and another user via the private messaging interface 612c on successful matching of the user expectation extracted from the recruitment advisory information with the recruiting requirement. The message interface module 608 defines instructions for grouping the exchanged messages of another user for unified access by a user.

The rating module 609 defines instructions for dynamically assigning a rating to each of the users based on the roles associated with each of the users, the acquired profile information, an outcome of a transaction performed between one or more recruiters and one or more candidates from the generated candidate list, and predetermined rating criteria associated with the roles. The rating module 609 defines instructions for assigning weights to the profiles of each of the users based on the roles and weighting criteria, and for computing the rating for each of the users based on the assigned weights.

The tracking module 606 defines instructions for tracking the outcome of the transaction between the recruiters and the candidates for a predetermined time period. The incentive allocation module 610 defines instructions for allocating incentives to each of the users based on the roles, the assigned rating, and predetermined incentive allocation criteria. The incentive allocation module 610 defines instructions for collecting incentives from the recruiter and/or the employers and for allocating the collected incentives to the users who provide the recruitment advisory information. Moreover, the incentive allocation module 610 defines instructions for allocating the incentives based on the authenticity of the acquired recruitment advisory information. Furthermore, the incentive allocation module 610 defines instructions for allocating the incentives to one or more recommenders and one or more screeners who have recommended and screened the candidates respectively, for each successful outcome of the transaction between the recruiters and the candidates.

The processor 701 of the computer system 700 employed by the recruitment interaction management platform 601 retrieves the instructions defined by the information acquisition module 602, the profile management module 603, the screening module 604, the matching module 607, the rating module 609, the incentive allocation module 610, the authentication module 605, the message interface module 608, the tracking module 606, etc., of the recruitment interaction management platform 601, and executes the instructions.

At the time of execution, the instructions stored in the instruction register are examined to determine the operations to be performed. The processor 701 then performs the specified operations. The operations comprise arithmetic operations and logic operations. The operating system performs multiple routines for performing a number of tasks required to assign the input devices 707, the output devices 710, and memory for execution of the modules, for example, 602, 603, 604, 605, 606, 607, 608, 609, 610, 611, etc., of the recruitment interaction management platform 601. The tasks performed by the operating system comprise, for example, assigning memory to the modules, for example, 602, 603, 604, 605, 606, 607, 608, 609, 610, 611, etc., of the recruitment interaction management platform 601, and to data used by the recruitment interaction management platform 601, moving data between the memory unit 702 and disk units, and handling input/output operations. The operating system performs the tasks on request by the operations and after performing the tasks, the operating system transfers the execution control back to the processor 701. The processor 701 continues the execution to obtain one or more outputs. The outputs of the execution of the modules, for example, 602, 603, 604, 605, 606, 607, 608, 609, 610, 611, etc., of the recruitment interaction management platform 601 are displayed to the user on the display unit 706.

For purposes of illustration, the detailed description refers to the recruitment interaction management platform 601 being run locally on a computer system 700; however the scope of the computer implemented method and system 600 disclosed herein is not limited to the recruitment interaction management platform 601 being run locally on the computer system 700 via the operating system and the processor 701, but may be extended to run remotely over the network 613 by employing a web browser and a remote server, a mobile phone, or other electronic devices.

Disclosed herein is also a computer program product comprising a non-transitory computer readable storage medium that stores computer program codes comprising instructions executable by at least one processor 701 for managing recruitment interactions among multiple users associated with multiple roles. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 701, except for a transitory, propagating signal.

The computer program codes comprise a first computer program code for acquiring profile information from each of the users associated with multiple roles via the GUI 612, where the acquired profile information is associated with the roles to be performed by each of the users; a second computer program code for acquiring recruitment advisory information from one or more of the users via the GUI 612 based on the roles of each of the users, and one or more first external sources via the network 613; a third computer program code for creating one or more candidate profiles for candidates using the recruitment advisory information and/or the acquired profile information; a fourth computer program code for matching the created candidate profiles with a recruiting requirement acquired from one or more of the users via the GUI 612 and/or one or more second external sources via the network 613 based on matching criteria to generate a sorted candidate list that matches the recruiting requirement; a fifth computer program code for dynamically assigning a rating to each of the users based on the roles associated with each of the users, the acquired profile information, an outcome of a transaction performed between one or more recruiters and one or more of the candidates from the generated candidate list, and predetermined rating criteria associated with the roles; and a sixth computer program code for allocating incentives to each of the users based on the roles, the assigned rating, and/or the predetermined incentive allocation criteria. The computer program product disclosed herein further comprises one or more additional computer program codes for performing additional steps that may be required and contemplated for managing recruitment interactions among multiple users associated with multiple roles. In an embodiment, a single piece of computer program code comprising computer executable instructions performs one or more steps of the computer implemented method disclosed herein for managing recruitment interactions among multiple users associated with multiple roles.

The computer program codes comprising computer executable instructions are embodied on the non-transitory computer readable storage medium. The processor 701 of the computer system 700 retrieves these computer executable instructions and executes them. When the computer executable instructions are executed by the processor 701, the computer executable instructions cause the processor 701 to perform the steps of the computer implemented method for managing recruitment interactions among multiple users associated with multiple roles.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises one or more computer program codes for implementing the processes of various embodiments.

Where databases are described such as the information database 611, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for managing recruitment interactions among a plurality of users associated with a plurality of roles, comprising:
providing a recruitment interaction management platform comprising at least one processor configured to manage said recruitment interactions among said users, wherein said recruitment interaction management platform is accessible to said users via a network;
acquiring profile information from each of said users via a graphical user interface provided by said recruitment interaction management platform, wherein said acquired profile information is associated with said roles to be performed by said each of said users on said recruitment interaction management platform;
acquiring recruitment advisory information from one or more of: one or more of said users via said graphical user interface based on one or more of said roles of each of said one or more of said users, and one or more first external sources via said network, by said recruitment interaction management platform;
creating one or more candidate profiles for candidates among said users using one or more of said recruitment advisory information and said acquired profile information by said recruitment interaction management platform;
matching said created one or more candidate profiles with a recruiting requirement acquired from one or more of: one or more of said users via said graphical user interface and one or more second external sources via said network by said recruitment interaction management platform based on matching criteria to generate a candidate list that matches said recruiting requirement;
dynamically assigning a rating to each of said users by said recruitment interaction management platform based on said roles associated with said each of said users, said acquired profile information, an outcome of a transaction performed between one or more of a plurality of recruiters among said users and one or more of said candidates from said generated candidate list, and predetermined rating criteria associated with said roles; and
allocating incentives to said each of said one or more of said users based on said one or more of said roles, said assigned rating, and predetermined incentive allocation criteria, by said recruitment interaction management platform.

2. The computer implemented method of claim 1, wherein said roles to be performed by said each of said users comprise a recruiter role, a screener role, a recommender role, an active candidate role, and a passive candidate role.

3. The computer implemented method of claim 1, wherein said recruitment advisory information comprises one or more of information on said recruiting requirement acquired from said one or more of said users and said one or more second external sources, one or more menu-driven recommendations acquired from said one or more of said users, one or more screening results acquired from said one or more of said users, user expectation information acquired from said one or more of said users, and feedback information acquired from said one or more of said users via said graphical user interface and said one or more second external sources via said network.

4. The computer implemented method of claim 1, wherein said profile information comprises login information, identification information, contact information, qualification information, domains of expertise, and links to third party sources that store said profile information of said each of said users.

5. The computer implemented method of claim 1, further comprising utilizing said recruitment advisory information by said recruitment interaction management platform for creating development programs and performance programs within an organization and for performing internal said recruitment interactions within said organization.

6. The computer implemented method of claim 1, wherein said predetermined rating criteria associated with said roles comprise one or more of votes from said users, a number of said candidates successfully recruited by said one or more of said recruiters, feedback from said one or more of said recruiters on a status of said transaction with each of said one or more of said candidates, a score assigned to each of one or more of said candidates selected by said one or more of said recruiters, and timestamps of recommendations extracted from said recruitment advisory information.

7. The computer implemented method of claim 1, wherein said predetermined incentive allocation criteria comprise said one or more of said roles performed by said each of said users, timestamps of recommendations extracted from said recruitment advisory information, a measure of a contribution of each of said one or more of said users during said recruitment interactions associated with said one or more of said candidates, and progress of said one or more of said candidates being hired across multiple organizations.

8. The computer implemented method of claim 1, wherein said matching criteria comprise one or more of educational qualifications, number of years of professional experience, professional skills, location, work environment of an organization, financial benefits provided by said organization, one or more menu-driven recommendations, user expectation information, and one or more screening results extracted from said recruitment advisory information.

9. The computer implemented method of claim 1, further comprising configuring user adjustable privacy settings for providing selective access of said acquired profile information of said each of said users to other of said users and for maintaining anonymity during said recruitment interactions.

10. The computer implemented method of claim 1, wherein said graphical user interface of said recruitment interaction management platform comprises one or more context sensitive interface elements that display contextual information based on preliminary inputs received from said each of said users.

11. The computer implemented method of claim 1, further comprising verifying authenticity of said recruitment advisory information by said recruitment interaction management platform, wherein said recruitment interaction management platform allocates said incentives to said each of said one or more of said users based on said authenticity of said recruitment advisory information.

12. The computer implemented method of claim 1, further comprising providing a private messaging interface by said recruitment interaction management platform for exchanging messages between one of said users and another one of said users in one or more of a plurality of communication modes, wherein identification information of said users is not revealed during said exchange.

13. The computer implemented method of claim 12, further comprising grouping said exchanged messages of said another one of said users by said recruitment interaction management platform for unified access by said one of said users.

14. The computer implemented method of claim 12, wherein said recruitment interaction management platform initiates said exchange of said messages between said one of said users and said another one of said users via said private messaging interface on successful said matching of user expectation information extracted from said acquired requirement advisory information with said recruiting requirement.

15. The computer implemented method of claim 1, further comprising acquiring requests for screening one or more of said candidates by said recruitment interaction management platform via said graphical user interface, automatically assigning said acquired requests for said screening to one or more screeners among said users by said recruitment interaction management platform, and displaying aggregated results of said screening received from said one or more screeners to said one or more of said recruiters on said graphical user interface by said recruitment interaction management platform.

16. The computer implemented method of claim 1, wherein said assignment of said rating to said each of said users by said recruitment interaction management platform comprises assigning weights to profiles of said each of said users based on said roles and weighting criteria, and computing said rating for said each of said users based on said assigned weights.

17. The computer implemented method of claim 1, wherein said generation of said candidate list that matches said recruiting requirement by said recruitment interaction management platform is performed by processing recommendations, screening results, and user expectation information extracted from said recruitment advisory information, and sorting said created one or more candidate profiles based on predefined categories.

18. The computer implemented method of claim 1, further comprising collecting said incentives from said one or more of said recruiters and performing said allocation of said collected incentives to said one or more of said users who provide said recruitment advisory information, by said recruitment interaction management platform.

19. The computer implemented method of claim 1, further comprising tracking said outcome of said transaction between said one or more of said recruiters and said one or more of said candidates by said recruitment interaction management platform for a predetermined time period, and allocating said incentives to one or more recommenders and one or more screeners among said users that recommend and screen said one or more of said candidates respectively, by said recruitment interaction management platform for each successful said outcome of said transaction between said one or more of said recruiters and said one or more of said candidates.

20. The computer implemented method of claim 1, further comprising providing a configurable taxonomization interface on said graphical user interface by said recruitment interaction management platform for dynamically acquiring taxonomies from said one or more of said users for classifying said created one or more candidate profiles of said candidates.

21. The computer implemented method of claim 1, further comprising sorting said generated candidate list in a predefined priority order by said recruitment interaction management platform.

22. The computer implemented method of claim 1, wherein said recruitment interaction management platform manages said recruitment interactions among said users independent of said recruiting requirement.

23. A computer implemented system for managing recruitment interactions among a plurality of users associated with a plurality of roles, comprising:
a recruitment interaction management platform accessible to said users via a network, said recruitment interaction management platform comprising at least one processor configured to execute modules of said recruitment interaction management platform for managing said recruitment interactions among said users, said modules of said recruitment interaction management platform comprising:
an information acquisition module that acquires profile information from each of said users via a graphical user interface provided by said recruitment interaction management platform, wherein said acquired profile information is associated with said roles to be performed by said each of said users on said recruitment interaction management platform;
said information acquisition module that acquires recruitment advisory information from one or more of: one or more of said users via said graphical user interface based on one or more of said roles of each of said one or more of said users, and one or more first external sources via said network;
a profile management module that creates one or more candidate profiles for candidates among said users using one or more of said recruitment advisory information and said acquired profile information;
a matching module that matches said created one or more candidate profiles with a recruiting requirement acquired from one or more of: one or more of said users via said graphical user interface and one or more second external sources via said network based on matching criteria to generate a candidate list that matches said recruiting requirement;
a rating module that dynamically assigns a rating to each of said users based on said roles associated with said each of said users, said acquired profile information, an outcome of a transaction performed between one or more of a plurality of recruiters among said users and one or more of said candidates from said generated candidate list, and predetermined rating criteria associated with said roles; and
an incentive allocation module that allocates incentives to said each of said one or more of said users based on said one or more of said roles, said assigned rating, and predetermined incentive allocation criteria.

24. The computer implemented system of claim 23, wherein said recruitment advisory information comprises one or more of information on said recruiting requirement acquired from said one or more of said users and said one or more second external sources, one or more menu-driven recommendations acquired from said one or more of said users, one or more screening results acquired from said one or more of said users, user expectation information acquired from said one or more of said users, and feedback information acquired from said one or more of said users via said graphical user interface and said one or more second external sources via said network.

25. The computer implemented system of claim 23, wherein said profile information comprises login information, identification information, contact information, qualification information, domains of expertise, and links to third party sources that store said profile information of said each of said users.

26. The computer implemented system of claim 23, wherein said profile management module configures user adjustable privacy settings for providing selective access of said acquired profile information of said each of said users to other of said users and for maintaining anonymity during said recruitment interactions.

27. The computer implemented system of claim 23, wherein said modules of said recruitment interaction management platform further comprise an information database that implements one or more of load balancing, caching, and database scaling for optimally storing said acquired profile information, said created one or more candidate profiles, and said recruitment advisory information.

28. The computer implemented system of claim 23, wherein said modules of said recruitment interaction management platform further comprise an authentication module that verifies authenticity of said recruitment advisory information, and wherein said incentive allocation module in communication with said authentication module, allocates said incentives to said each of said one or more of said users based on said authenticity of said recruitment advisory information.

29. The computer implemented system of claim 23, wherein said modules of said recruitment interaction management platform further comprise a message interface module that provides a private messaging interface for exchanging messages between one of said users and another one of said users in one or more of a plurality of communication modes, wherein identification information of said users is not revealed during said exchange, and wherein said message interface module initiates said exchange of said messages between said one of said users and said another one of said users via said private messaging interface on successful said matching of user expectation information extracted from said acquired requirement advisory information with said recruiting requirement.

30. The computer implemented system of claim 29, wherein said message interface module groups said exchanged messages of said another one of said users for unified access by said one of said users.

31. The computer implemented system of claim 23, wherein said modules of said recruitment interaction management platform further comprise a screening module that performs:
acquiring requests for screening one or more of said candidates via said graphical user interface;
automatically assigning said acquired requests for said screening to one or more screeners among said users; and
displaying aggregated results of said screening received from said one or more screeners to said one or more of said recruiters on said graphical user interface.

32. The computer implemented system of claim 23, wherein said rating module assigns said rating to said each of said users by:
assigning weights to profiles of said each of said users based on said roles and weighting criteria; and
computing said rating for said each of said users based on said assigned weights.

33. The computer implemented system of claim 23, wherein said matching module performs:
processing recommendations, screening results, and user expectation information extracted from said recruitment advisory information; and
sorting said created one or more candidate profiles based on predefined categories.

34. The computer implemented system of claim 23, wherein said incentive allocation module collects said incentives from said one or more of said recruiters and performs said allocation of said collected incentives to said one or more of said users who provide said recruitment advisory information.

35. The computer implemented system of claim 23, wherein said modules of said recruitment interaction management platform further comprise a tracking module that tracks said outcome of said transaction between said one or more of said recruiters and said one or more of said candidates for a predetermined time period, and wherein said incentive allocation module, in communication with said tracking module, allocates said incentives to one or more recommenders and one or more screeners among said users that recommend and screen said one or more of said candidates respectively, for each successful said outcome of said transaction between said one or more of said recruiters and said one or more of said candidates.

36. The computer implemented system of claim 23, wherein said graphical user interface of said recruitment interaction management platform comprises a configurable taxonomization interface for dynamically acquiring taxonomies from said one or more of said users for classifying said created one or more candidate profiles of said candidates.

37. A computer program product comprising a non-transitory computer readable storage medium, said non-transitory computer readable storage medium storing computer program codes that comprise instructions executable by at least one processor, said computer program codes comprising:
a first computer program code for acquiring profile information from each of a plurality of users associated with a plurality of roles via a graphical user interface, wherein said acquired profile information is associated with said roles to be performed by said each of said users;
a second computer program code for acquiring recruitment advisory information from one or more of: one or more of said users via said graphical user interface based on one or more of said roles of each of said one or more of said users and one or more first external sources via a network;
a third computer program code for creating one or more candidate profiles for candidates among said users using one or more of said recruitment advisory information and said acquired profile information;
a fourth computer program code for matching said created one or more candidate profiles with a recruiting requirement acquired from one or more of: one or more of said users via said graphical user interface and one or more second external sources via said network based on matching criteria to generate a candidate list that matches said recruiting requirement;
a fifth computer program code for dynamically assigning a rating to each of said users based on said one or more of said roles associated with said each of said users, said acquired profile information, an outcome of a transaction performed between one or more of a plurality of recruiters among said users and one or more of said candidates from said generated candidate list, and predetermined rating criteria associated with said one or more of said roles; and
a sixth computer program code for allocating incentives to said each of said one or more of said users based on said one or more of said roles, said assigned rating, and predetermined incentive allocation criteria.
